(19) United States
(12) Patent Application Publication
(10) Pub. No.: US 2022/0094466 A1
(43) Pub. Date: Mar. 24, 2022

(54) COMMUNICATION DEVICE, CONTROL DEVICE, AND COMMUNICATION SYSTEM

(71) Applicant: Sony Group Corporation, Tokyo (JP)

(72) Inventor: Hiromasa UCHIYAMA, Tokyo (JP)

(73) Assignee: Sony Group Corporation, Tokyo (JP)

(21) Appl. No.: 17/419,292

(22) PCT Filed: Dec. 25, 2019
(86) PCT No.: PCT/JP2019/051024

§ 371 Date: Jun. 29, 2021

(30) Foreign Application Priority Data
Feb. 14, 2019 (JP) 2019-024881

(51) Int. Cl. H04L 1/00; H04L 1/18; H04L 5/00

(52) U.S. Cl. CPC H04L 1/0025; H04L 1/0017; H04W 92/18; H04L 5/0053; H04L 1/1812

(57) ABSTRACT

A communication device includes a communication unit that performs radio communication; and a control unit that performs control so as to switch an HARQ feedback mode in a communication scheme of inter-device communicating with another device through the radio unit between a first mode in which NACK-based feedback is performed and a second mode in which ACK/NACK-based feedback is performed, in which the control unit controls switching of an HARQ feedback mode based on information about an identifier of a group including the communication device and about the number of devices in the group.

### FIELD

The present disclosure relates to a communication device, a control device, and a communication system.

### BACKGROUND

In recent years, expectations for in-vehicle communication (V2X communication) have increased in order to realize autonomous driving in the future. The V2X communication is an abbreviation for Vehicle to X communication, which is a system in which “something” communicates with a car. Examples of “something” here include a vehicle, an infrastructure, a network, and a pedestrian (V2V, V2I, V2N, and V2P). For example, Patent Literature 1 discloses an example of a technique related to V2X communication.

In addition, as radio communication for vehicles, the development of an 802.11p-based dedicated short range communication (DSRC) has been mainly promoted, but in recent years, “LTE-based V2X”, which is LTE-based in-vehicle communication, has been standardized. The LTE-based V2X communication supports the exchange of basic safety messages.

### CITATION LIST

### Patent Literature

Patent Literature 1: JP 2017-208796 A

### SUMMARY

### Technical Problem

In 5G NR V2X communication, it is necessary to realize highly reliable and low-delay QoS-guaranteed communication. Especially in V2X communication in which direct communication is performed, there may be cases where a transmission resource cannot always be secured, or it may take time to allocate a resource from the base station. Therefore, a new QoS control method is required to realize high-reliability and low-delay QoS-guaranteed communication on the side link.

Therefore, in the present disclosure, in order to realize highly reliable and low-delay QoS-guaranteed communication in NR V2X communication, new and improved communication device, control device, and communication system capable of performing communication based on a new QoS control method are offered.

### Solution to Problem

According to the present disclosure, a communication device is provided that includes: a communication unit that performs radio communication; and a control unit that performs control so as to switch an HARQ feedback mode in a communication scheme of inter-device communicating with another device through the communication unit between a first mode in which NACK-based feedback is performed and a second mode in which ACK/NACK-based feedback is performed, wherein the control unit controls switching of an HARQ feedback mode based on information about an identifier of a group including the communication device and information about the number of devices in the group.

Moreover, according to the present disclosure, a control device is provided that includes: a communication unit that performs radio communication with a terminal device; and a control unit that performs control so as to switch an HARQ feedback mode in a communication scheme in which the terminal device performs inter-device communication with another device between a first mode in which NACK-based feedback is performed and a second mode in which ACK/NACK-based feedback is performed, wherein the control unit controls switching of an HARQ feedback mode based on information about an identifier of a group including the terminal device and information about the number of devices in the group.

Moreover, according to the present disclosure, a communication system is provided that includes at least two communication devices described above.

### BRIEF DESCRIPTION OF DRAWINGS

FIG. 1 is an explanatory diagram for explaining an example of a schematic configuration of a system according to an embodiment of the present disclosure.

FIG. 2 is a block diagram illustrating an example of a configuration of a base station according to the same embodiment.

FIG. 3 is a block diagram illustrating an example of a configuration of a terminal device according to the same embodiment.

FIG. 4 is a diagram illustrating an outline of V2X communication.

FIG. 5 is an explanatory diagram for explaining an example of an overall image of V2X communication.

FIG. 6 is a diagram illustrating an example of a use case of V2X communication.

FIG. 7 is an explanatory diagram for explaining an example of a V2X operation scenario.

FIG. 8 is an explanatory diagram for explaining an example of a V2X operation scenario.

FIG. 9 is an explanatory diagram for explaining an example of a V2X operation scenario.

FIG. 10 is an explanatory diagram for explaining an example of a V2X operation scenario.

FIG. 11 is an explanatory diagram for explaining an example of a V2X operation scenario.

FIG. 12 is an explanatory diagram for explaining an example of a V2X operation scenario.

FIG. 13 is an explanatory diagram illustrating an example of application to an in-vehicle base station.

FIG. 14 is an explanatory diagram illustrating an example of application to relay communication for wearable.

FIG. 15 is an explanatory diagram illustrating an example of application to a drone base station.

FIG. 16 is an explanatory diagram illustrating an example of application to a terminal base station.

FIG. 17 is a flow chart illustrating an operation example of the communication system according to the embodiment of the present disclosure.

FIG. 18 is a flow chart illustrating an operation example of a transmission terminal.

FIG. 19 is a flow chart illustrating an operation example of a reception terminal.

FIG. 20 is a flow chart illustrating an outline of application-linked QoS control according to the embodiment of the present disclosure.

FIG. 21 is a flow chart illustrating application-linked QoS control according to the embodiment of the present disclosure.

FIG. 22 is a flow chart illustrating application-linked QoS control according to the embodiment of the present disclosure.

FIG. 23 is a flow chart for explaining a channel access restriction (Admission control) in the application-linked QoS control according to the embodiment of the present disclosure.

FIG. 24 is a flow chart illustrating a channel access restriction in application-linked QoS control according to the embodiment of the present disclosure.

FIG. 25 is a flow chart illustrating a channel access restriction in application-linked QoS control according to the embodiment of the present disclosure.

FIG. 26 is a block diagram illustrating a first example of a schematic configuration of an eNB.

FIG. 27 is a block diagram illustrating a second example of a schematic configuration of an eNB.

FIG. 28 is a block diagram illustrating an example of a schematic configuration of a smartphone.

FIG. 29 is a block diagram illustrating an example of a schematic configuration of a car navigation device.

### DESCRIPTION OF EMBODIMENTS

Hereinafter, preferred embodiments of the present disclosure will be described in detail with reference to the accompanying drawings. Note that, in the present specification and drawings, redundant description of a component having substantially the same functional configuration is omitted by providing the same reference numeral.

The description will be given in the following order.

1. Configuration example

1.1. Example of system configuration

1.2. Base station configuration example

1.3. Terminal device configuration example

2. V2X communication

3. QoS control in V2X communication

3.1. QoS control for terminal group

3.2. Application-linked QoS control

4. Application example

4.1. Application example related to base stations

4.2. Application example related to terminal devices

5. Summary

### 1. CONFIGURATION EXAMPLE

### 1.1. Example of System Configuration

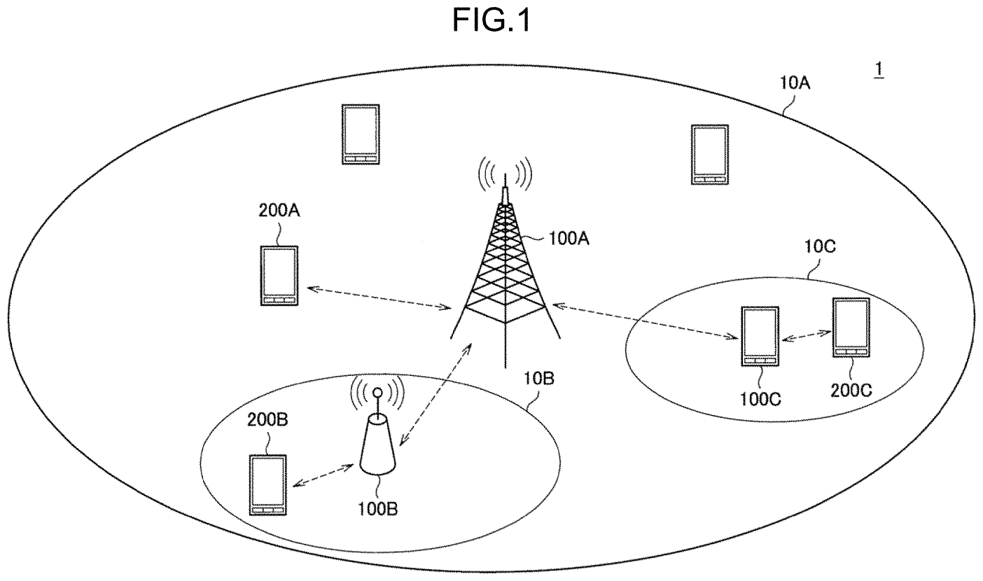

First, an example of a schematic configuration of a system 1 according to the embodiment of the present disclosure will be described with reference to FIG. 1. FIG. 1 is an explanatory diagram for explaining an example of a schematic configuration of the system 1 according to the embodiment of the present disclosure. As illustrated in FIG. 1, the system 1 includes a base station 100 and a terminal device 200. Here, the terminal device 200 is also referred to as a user. The user may also be referred to as a UE. A base station 100C is also referred to as a UE-Relay. The UE here may be the UE defined in an LTE or an LTE-A, and the UE-Relay may be the Prose UE to Network Relay discussed in 3GPP, more generally it may mean communication equipment.

(1) Base Station 100

The base station 100 is a device that provides a radio communication service to the devices under its control. For example, a base station 100A is a base station for a cellular system (or moving body communication system). The base station 100A performs radio communication with a device (for example, a terminal device 200A) located inside a cell 10A of the base station 100A. For example, the base station 100A transmits a downlink signal to the terminal device 200A and receives an uplink signal from the terminal device 200A.

The base station 100A is logically connected to another base station by, for example, an X2 interface, and can transmit and receive control information and the like. Further, the base station 100A is logically connected to a so-called core network (not illustrated) by, for example, an S1 interface, and can transmit and receive control information and the like. Communication between these devices can be physically relayed by various devices.

Here, the base station 100A illustrated in FIG. 1 is a macro cell base station, and the cell 10A is a macro cell. On the other hand, base stations 100B and 100C are master devices that operate the small cells 10B and 10C, respectively. As an example, the master device 100B is a fixedly installed small cell base station. The small cell base station 100B establishes a radio backhaul link with the macro cell base station 100A and an access link with one or a plurality of terminal devices (for example, a terminal device 200B) inside the small cell 10B. The base station 100B may be a relay node defined by 3GPP. The master device 100C is a dynamic access point (AP). The dynamic AP 100C is a mobile device that dynamically operates the small cell 10C. The dynamic AP 100C establishes a radio backhaul link with the macro cell base station 100A and an access link with one or a plurality of terminal devices (for example, a terminal device 200C) inside the small cell 10C. The dynamic AP 100C may be, for example, a terminal device equipped with hardware or software capable of operating as a base station or a radio access point. The small cell 10C in this case is a dynamically formed localized network/virtual cell.

The cell 10A may be operated according to any radio communication system such as an LTE, an LTE-Advanced (LTE-A), an LTE-ADVANCED PRO, a GSM (registered trademark), a UMTS, a W-CDMA, a CDMA2000, a WiMAX, a WiMAX2, or an IEEE802.16.

It should be noted that the small cell is a concept that can include various types of cells smaller than the macro cell (for example, a femtocell, a nanocell, a picocell, a microcell, and the like) that are disposed so as to overlap or not to overlap with the macro cell. In an example, the small cell is operated by a dedicated base station. In another example, the small cell is operated by the terminal serving as the master device temporarily operating as a small cell base station. The so-called relay node can also be considered as a form of small cell base station. A radio communication device that functions as a master station of a relay node is also referred to as a donor base station. The donor base station may mean a DeNB in LTE, or more generally the master station of a relay node.

(2) Terminal Device 200

The terminal device 200 can communicate in a cellular system (or moving body communication system). The terminal device 200 performs radio communication with a radio communication device (for example, base station 100A, master device 100B or 100C) of the cellular system. For example, the terminal device 200A receives the downlink signal from the base station 100A, and transmits the uplink signal to the base station 100A.

Further, the terminal device 200 is not limited to the so-called UE, but for example, may be a so-called low cost terminal (Low cost UE) such as an MTC terminal, an enhanced MTC (eMTC) terminal, and an NB-IoT terminal. Further, an infrastructure terminal such as a road side unit (RSU) or a terminal such as customer premises equipment (CPE) may be applied.

(3) Supplement

Although the schematic configuration of the system 1 has been illustrated above, the present technology is not limited to the example illustrated in FIG. 1. For example, the configuration of the system 1 may include a configuration that does not include a master device, a small cell enhancement (SCE), a heterogeneous network (HetNet), an MTC network, or the like. Further, as another example of the configuration of the system 1, the master device may be connected to the small cell and the cell may be constructed under the small cell.

### 1.2. Base Station Configuration Example

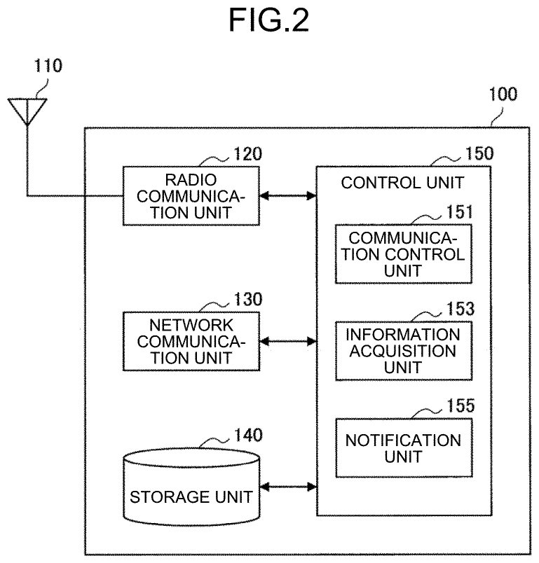

Next, the configuration of the base station 100 according to the embodiment of the present disclosure will be described with reference to FIG. 2. FIG. 2 is a block diagram illustrating an example of the configuration of the base station 100 according to the embodiment of the present disclosure. Referring to FIG. 2, the base station 100 includes an antenna unit 110, a radio communication unit 120, a network communication unit 130, a storage unit 140, and a control unit 150.

(1) Antenna Unit 110

The antenna unit 110 radiates the signal output by the radio communication unit 120 into space as radio waves. Further, the antenna unit 110 converts a radio wave in space into a signal to output the signal to the radio communication unit 120.

(2) Radio Communication Unit 120

The radio communication unit 120 transmits and receives signals. For example, the radio communication unit 120 transmits a downlink signal to the terminal device and receives an uplink signal from the terminal device.

(3) Network Communication Unit 130

The network communication unit 130 transmits and receives information. For example, the network communication unit 130 transmits information to another node and receives information from another node. For example, the other node includes another base station and a core network node.

As described above, in the system 1 according to the present embodiment, the terminal device may operate as a relay terminal and relay the communication between the remote terminal and the base station. In such a case, for example, the base station 100C corresponding to the relay terminal may not include the network communication unit 130.

(4) Storage Unit 140

The storage unit 140 temporarily or permanently stores the program and various pieces of data for the operation of the base station 100.

(5) Control Unit 150

The control unit 150 provides various functions of the base station 100. The control unit 150 includes a communication control unit 151, an information acquisition unit 153, and a notification unit 155. The control unit 150 may further include other components other than these components. That is, the control unit 150 can perform operations other than the operations of these components.

The communication control unit 151 executes various processes related to the control of radio communication with the terminal device 200 via the radio communication unit 120. Further, the communication control unit 151 executes various processes related to the control of communication with other nodes (for example, other base stations, core network nodes, and the like) via the network communication unit 130. Further, the communication control unit 151 controls switching of the HARQ feedback mode described later. The communication control unit 151 performs the QoS control determination described later.

The information acquisition unit 153 acquires various pieces of information from the terminal device 200 and other nodes. The acquired information may be used, for example, for controlling radio communication with a terminal device, controlling for cooperation with other nodes, and the like.

The notification unit 155 notifies the terminal device 200 and other nodes of various pieces of information. As a specific example, the notification unit 155 may notify the terminal device of various pieces of information for the terminal device in the cell to perform radio communication with the base station. Further, as another example, the notification unit 155 may notify another node (for example, another base station) of the information acquired from the terminal device in the cell. Further, the notification unit 155 can provide the terminal device 200 with information that controls switching of the HARQ feedback mode, which will be described later. Further, the notification unit 155 can provide the terminal device 200 with information about the inter-device communication as a result of the QoS control determination described later.

### 1.3. Terminal Device Configuration Example

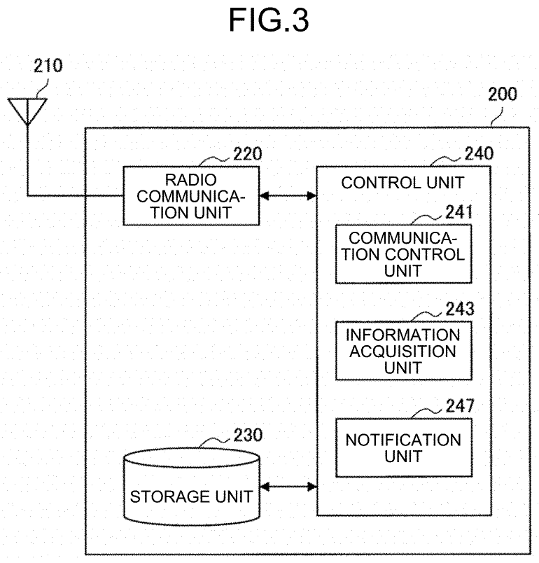

Next, an example of the configuration of the terminal device 200 according to the embodiment of the present disclosure will be described with reference to FIG. 3. FIG. 3 is a block diagram illustrating an example of the configuration of the terminal device 200 according to the embodiment of the present disclosure. As illustrated in FIG. 3, the terminal device 200 includes an antenna unit 210, a radio communication unit 220, a storage unit 230, and a control unit 240.

(1) Antenna Unit 210

The antenna unit 210 radiates the signal output by the radio communication unit 220 into space as a radio wave. Further, the antenna unit 210 converts the radio wave in the space into a signal to output the signal to the radio communication unit 220.

(2) Radio Communication Unit 220

The radio communication unit 220 transmits and receives signals. For example, the radio communication unit 220 receives a downlink signal from the base station and transmits an uplink signal to the base station.

Further, in the system 1 according to the present embodiment, the terminal device 200 may directly communicate with another terminal device 200 without going through the base station 100. In this case, the radio communication unit 220 may transmit and receive a side link signal to and from another terminal device 200.

(3) Storage Unit 230

The storage unit 230 temporarily or permanently stores the program and various pieces of data for the operation of the terminal device 200.

(4) Control Unit 240

The control unit 240 provides various functions of the terminal device 200. For example, the control unit 240 includes a communication control unit 241, an information acquisition unit 243, and a notification unit 247. The control unit 240 may further include other components other than these components. That is, the control unit 240 can perform operations other than the operations of these components.

The communication control unit 241 executes various processes related to the control of radio communication with the base station 100 and another terminal device 200 via the radio communication unit 220. For example, the communication control unit 241 can execute control related to switching of the HARQ feedback mode described later.

Further, the communication control unit 241 may make a predetermined determination based on the information acquired from the base station 100 or another terminal device 200. As a more specific example, the communication control unit 241 may determine whether a packet can be transmitted to another terminal device 200. Further, at this time, the communication control unit 241 may determine whether to drop the packet scheduled to be transmitted to another terminal device 200.

The information acquisition unit 243 acquires various pieces of information from the base station 100 and another terminal device 200. As a specific example, the information acquisition unit 243 may acquire information (for example, reception capability, and the like) about another terminal device 200 from the other terminal device 200. Further, the information acquisition unit 243 may acquire various pieces of information for selecting resources to be used for communication with another terminal device 200 from the base station 100 or another terminal device 200. As a more specific example, the information acquisition unit 243 may acquire information about a resource reserved by another terminal device 200 from the other terminal device 200. Further, the information acquisition unit 243 can acquire information for control regarding switching of the HARQ feedback mode, which will be described later, by performing sensing or from another device.

The notification unit 247 notifies the base station 100 and another terminal device 200 of various pieces of information. As a specific example, the notification unit 247 may notify another terminal device 200 (for example, the terminal device 200 to which the data or packet is transmitted) of information about the data or packet to be transmitted. Further, the notification unit 247 may notify another terminal device 200 of information about a resource reserved for use in transmitting the packet. In addition, the notification unit 247 can notify another device of information about the switching of the HARQ feedback mode, which will be described later.

### 2. V2X COMMUNICATION

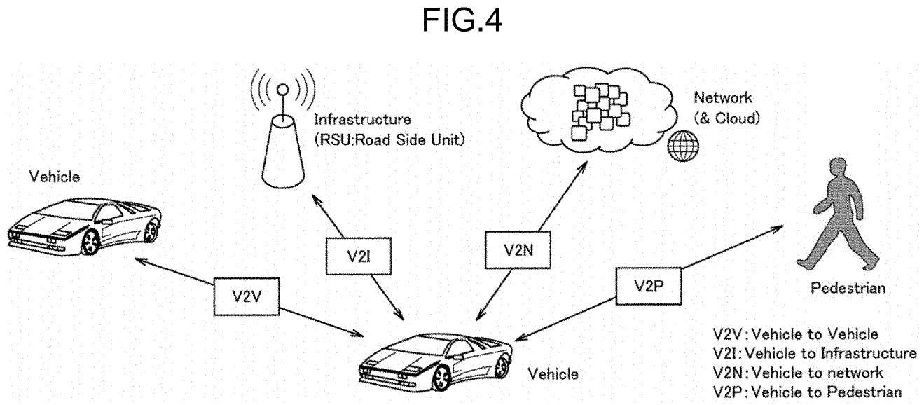

Next, the outline of V2X communication will be described. The V2X communication is an abbreviation for Vehicle to X communication, which is a system in which “something” communicates with a car. For example, FIG. 4 is a diagram illustrating an outline of V2X communication. Examples of “something” here include a vehicle, an infrastructure, a network, a pedestrian, and the like (V2V, V2I, V2N, and V2P) as illustrated in FIG. 4.

(Overview of V2X Communication)

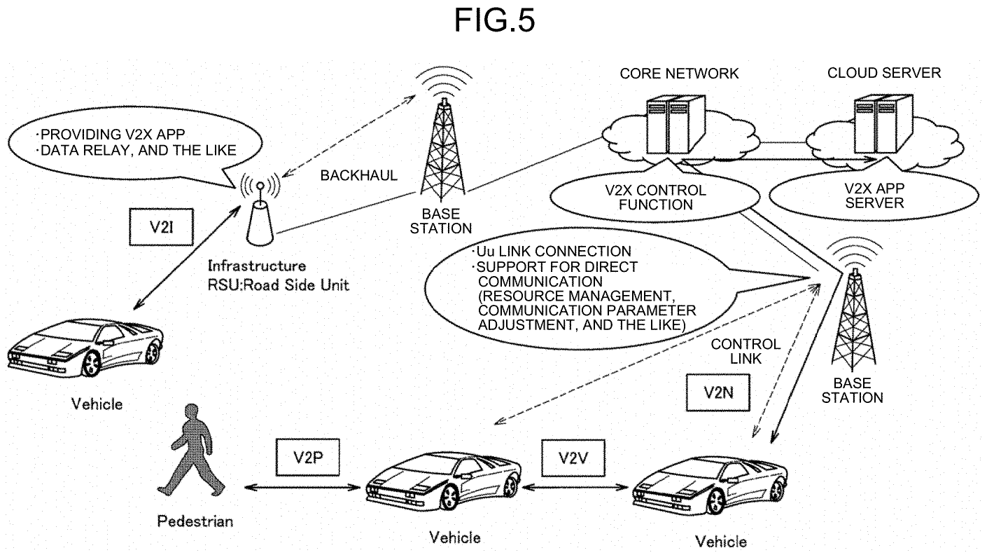

Further, FIG. 5 is an explanatory diagram for explaining an example of the overall image of V2X communication. In the example illustrated in FIG. 5, a V2X application server (APP server) is held as a cloud server, and the application server controls V2X communication on the core network side. The base station performs Uu-link communication with the terminal device, while controlling communication for direct communication such as V2V communication and V2P communication. In addition to the base station, a road side unit (RSU) is placed as a roadside infrastructure. There are two possible RSUs, a base station type RSU and a UE type RSU. In RSU, the V2X application (V2X APP) will be provided and support such as data relay will be provided.

(V2X Communication Use Case)

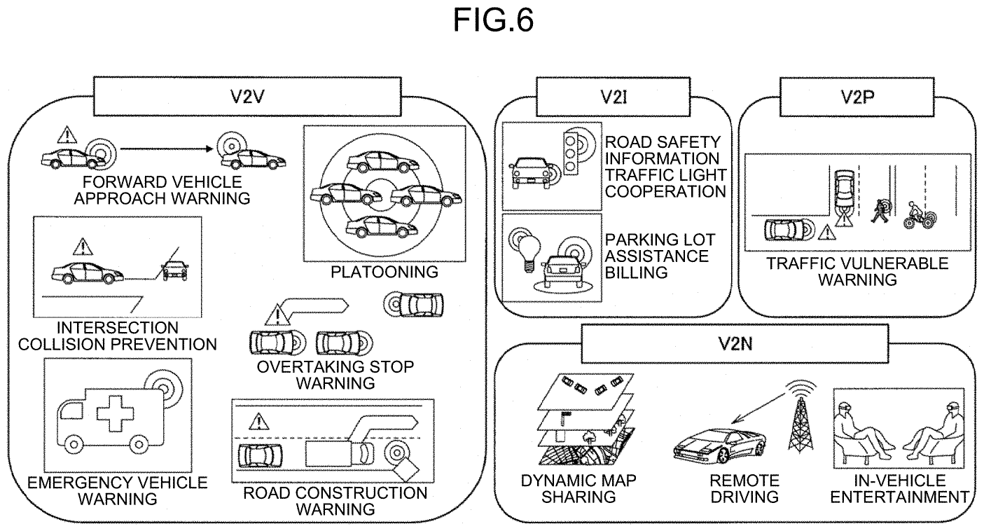

As radio communication for vehicles, the development of an 802.11p-based dedicated short range communication (DSRC) has been mainly promoted, but in recent years, “LTE-based V2X (LTE-based V2X communication)”, which is LTE-based in-vehicle communication, has been standardized. The LTE-based V2X communication supports the exchange of basic safety messages. On the other hand, with the aim of further improving V2X communication, NR V2X communication using 5G technology (NR: New Radio) has been studied in recent years. For example, FIG. 6 is a diagram illustrating an example of a use case of V2X communication.

The NR V2X communications support new use cases that require high reliability, low-delay, high speed communication, and high capacity that were previously difficult to support with the LTE-based V2X. As a specific example, among the examples illustrated in FIG. 6, for example, provision of a dynamic map, remote driving, and the like can be included. In addition to this, included are a sensor data sharing in which sensor data is exchanged between vehicles and a road and a vehicle, and a platooning use case for platooning. The use case and requirements for such NR V2X communication are specified in 3GPP TR 22.886. For reference, an outline of an example of a use case will be described below.

(1) Vehicles Platoonning

This is a use case of platooning in which a plurality of vehicles forms a platoon and travels in the same direction, and information is exchanged between the vehicle leading the platooning and another vehicle to control the platooning. By exchanging such information, for example, it is possible to further reduce the inter-vehicle distance of platooning.

(2) Extended Sensors

This is a use case in which sensor-related information (raw data before data processing and data after processing) can be exchanged between vehicles. The sensor information is collected through a local sensor, a live video image (for example, a live video image between a surrounding vehicle, an RSU, and a pedestrian), a V2X application server, and the like. By exchanging these information, the vehicle will be able to acquire information that cannot be obtained from its own sensor information, and will be able to understand/recognize a wider range of environments. In this use case, since it is necessary to exchange a lot of information, a high data rate is required for communication.

(3) Advanced Driving

This is a use case that enables semi-automatic driving and fully automatic driving. In this use case, the RSU shares the understanding/recognition information obtained from its own sensors and the like with the surrounding vehicles so that each vehicle can adjust the track and operation in synchronization and cooperation with other vehicles. In addition, each vehicle can share the intention and purpose of driving with neighboring vehicles.

(4) Remote Driving

This is a use case in which a remote operator or the V2X application performs remote operation. The remote control is used when another person drives on behalf of a person who has difficulty in driving, or when operating a vehicle in a dangerous region. For public transportation, where routes and roads are fixed to some extent, cloud computing-based maneuvers can be applied, for example. In this use case, high reliability and low transmission delay are required for communication.

(Physical Layer Enhancement)

Further enhancement of the physical layer from LTE V2X is required to achieve the above requirements. Target links include a Uu link and a PC5 link (side link). The Uu link is a link between an infrastructure such as a base station or a road side unit (RSU) and a terminal device. The PC5 link (side link) is a link between terminal devices. The main points of enhancement are illustrated below.

Examples of enhancements include:

Channel format

Side link feedback communication

Side link resource allocation method

Vehicle position information estimation technology

Relay communication between terminals

Support for unicast communication and multicast communication

Multi-carrier communication, carrier aggregation

MIMO/beamforming

Radio frequency support (example: 6 GHz or higher)

Further, examples of the channel format include a flexible numerology, a short transmission time interval (TTI), a multi-antenna support, and a waveform, and the like. Further, examples of the side link feedback communication include an HARQ, channel status information (CSI), and the like.

(V2X Operation Scenario)

An example of a V2X communication operation scenario is described below. The V2N communication is only DL/UL communication between the base station and the terminal device, which is simple. On the other hand, in V2V communication, various communication paths can be considered. In the following, each scenario will be explained mainly focusing on the example of V2V communication, but the same communication operation can be applied to V2P and V2I. In V2P and V2I, the communication destination is a pedestrian or an RSU.

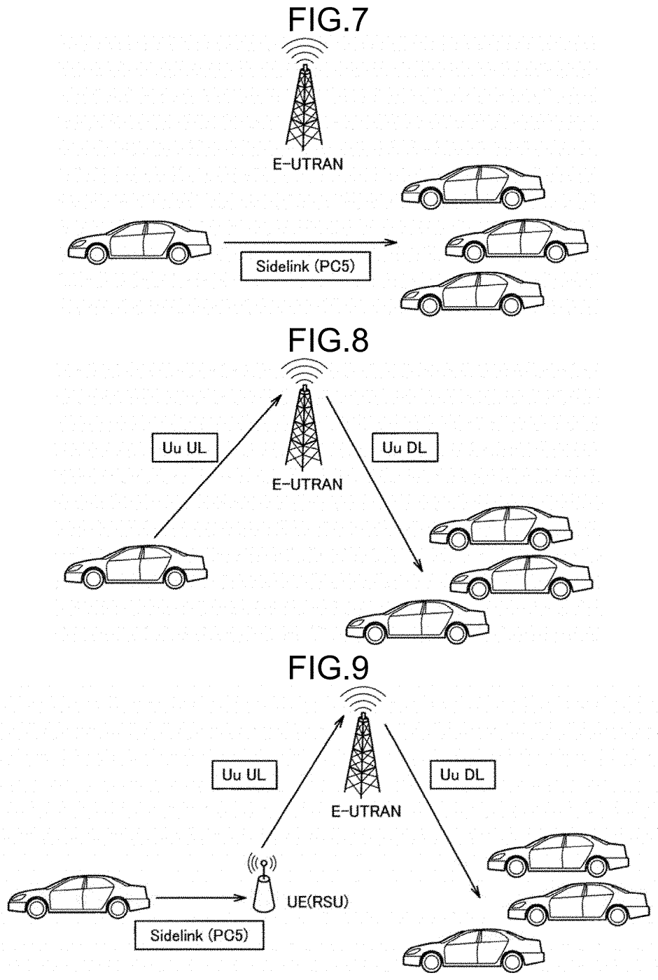

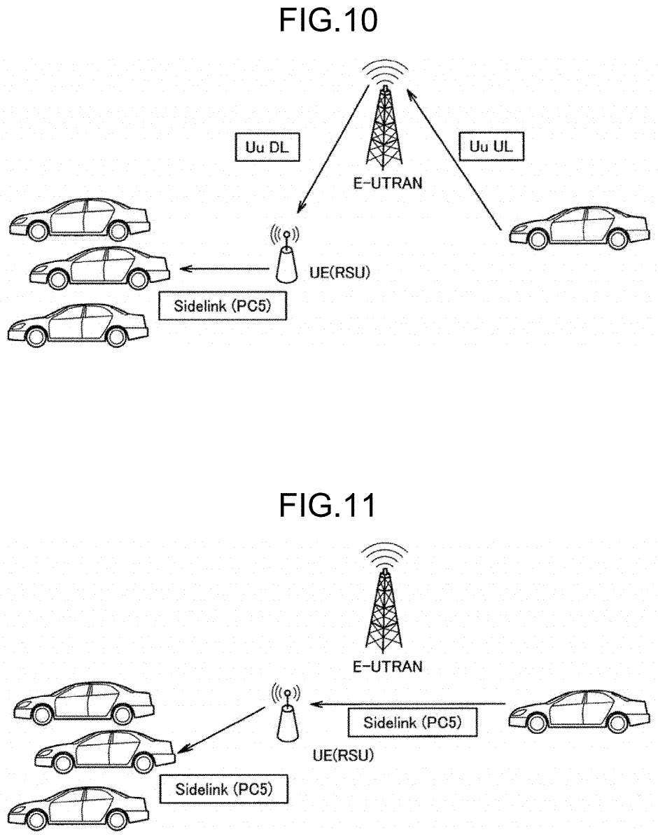

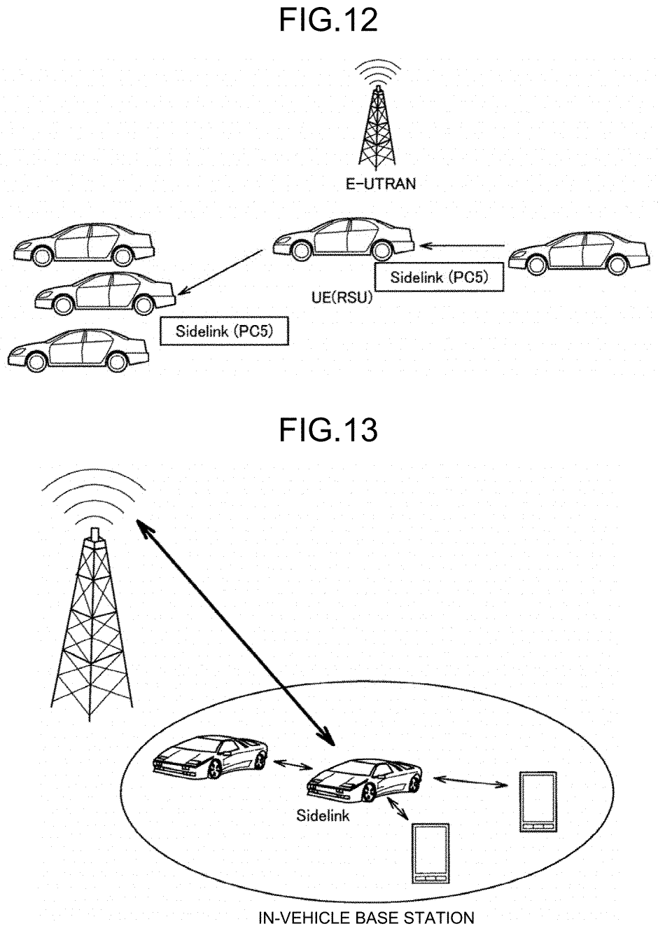

For example, FIGS. 7 to 12 are explanatory diagrams for explaining an example of a V2X operation scenario. Specifically, FIG. 7 illustrates a scenario in which vehicles communicate directly with each other without going through a base station (E-UTRAN). FIG. 8 illustrates a scenario in which vehicles communicate with each other via a base station. FIGS. 9 and 10 illustrate a scenario in which vehicles communicate with each other via a terminal device (a UE, here an RSU) and a base station. FIGS. 11 and 12 illustrate a scenario in which vehicles communicate with each other via a terminal device (a UE, here an RSU or another vehicle).

In addition, in FIGS. 7 to 12, the “side link” corresponds to a communication link between terminal devices and is also referred to as a PC5. Specific examples of side links include V2V, V2P, and V2I communication links. The “Uu interface” corresponds to a radio interface between a terminal device and a base station. A specific example of a Uu interface includes a V2N communication link. The “PC5 interface” corresponds to a radio interface between terminal devices.

The embodiments of the present disclosure are used for any side link communication (PC5 interface, and the like). Examples of the terminal device that performs side link communication may include a smartphone, an IoT device, a car, a drone, a consumer premises equipment (CPE), a road side unit (RSU), a wearable device, a medical device, robotics, and the like. Application examples of relay communication is illustrated below. The combination of terminal devices described here may be any combination of the above terminal devices.

FIG. 13 is an explanatory diagram illustrating an example of application to an in-vehicle base station. Although the terminal device is illustrated to be outside the vehicle in FIG. 13, the terminal device may of course be inside the vehicle. In addition, although only one vehicle is illustrated in FIG. 13, vehicle-to-vehicle communication between two vehicles is also possible. Further, the in-vehicle base station may be a terminal device, or may be an RSU or the like.

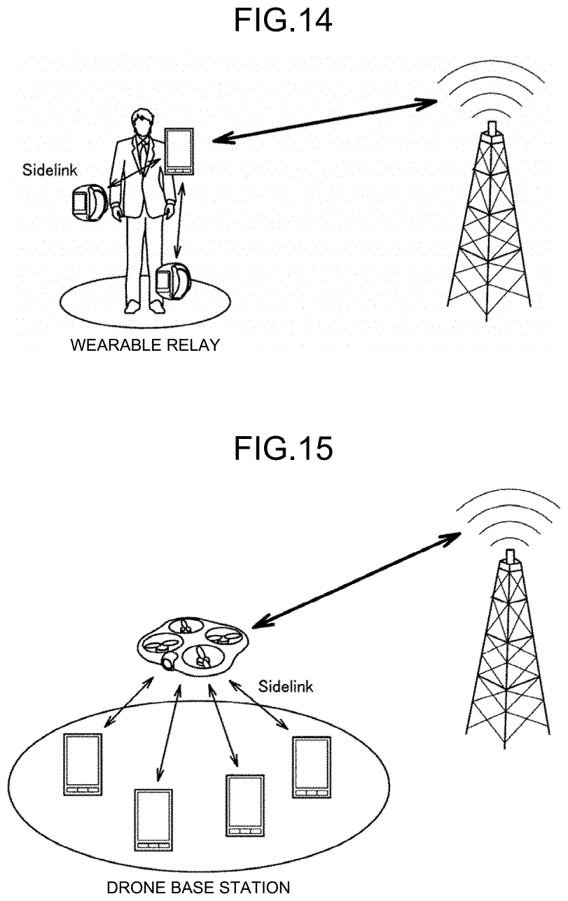

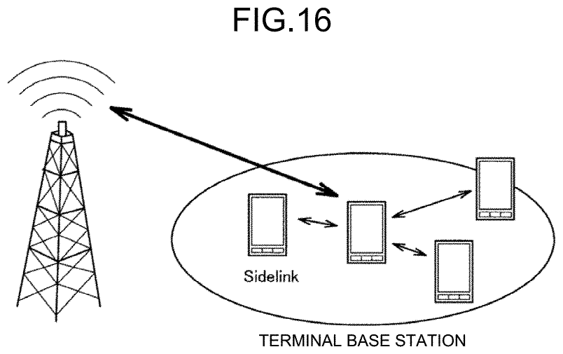

FIG. 14 is an explanatory diagram illustrating an example of application to relay communication for wearable. FIG. 15 is an explanatory diagram illustrating an example of application to a drone base station. FIG. 16 is an explanatory diagram illustrating an example of application to a terminal base station. In each of these examples, a wearable device, a drone, and a terminal device each have the role of a base station and perform side link communication with a terminal device.

### 3. QOS CONTROL IN V2X COMMUNICATION

As illustrated in the above use case, in 5G NR V2X communication, it is required to realize highly reliable and low-delay QoS-guaranteed communication. Especially in V2X communication in which direct communication is performed, there may be cases where a transmission resource cannot always be secured, or it may take time to allocate a resource from the base station. Therefore, a new QoS control method is required to realize high-reliability and low-delay QoS-guaranteed communication on the side link.

In LTE V2X, transmission parameter control using parameters such as a channel busy ratio (CBR) and a channel occupancy ratio (CR) is introduced as a QoS control method. The CBR is defined as the channel occupancy ratio, and when the channel is congested, the transmission terminal can change the transmission parameters to alleviate the congestion. Also, the CR has a ratio of how much channel the transmission of the own terminal occupies with respect to the given channel. In the case of CR as well, it is possible to adjust the fairness between users by controlling the transmission parameters in the same manner. In addition, the transmission terminal can control the QoS of the transmission packet by using prose per-packet priority (PPPP). By including the priority information associated with the PPPP in sidelink control information (SCI) when transmitting a side link packet, priority control between terminals is possible. As a result, for example, a transmission terminal having a packet having a high priority level can be controlled so that a resource having a high possibility of successful transmission can be easily obtained as compared with a terminal having a packet having a low priority level.

The above-mentioned operation is basically aimed at sharing the entire band equally among as many terminals as possible, and is a best-effort operation. On the other hand, as in 5G NR V2X communication, in communication in which more advanced high-reliability and low-delay communication is performed, a mechanism that can guarantee the QoS to some extent is required. In addition, new use cases such as platooning (following vehicle group traveling) will also appear in the terminal, and QoS control in group unit will be required. In the embodiment, a new QoS control method capable of handling the above requirements will be described.

The present embodiment is characterized in that the QoS control for a terminal group is performed. That is, the present embodiment is characterized in that the QoS control is performed for each group.

Further, the present embodiment is characterized in that application-linked QoS control is performed. For example, in the present embodiment, when the QoS control is required, such as when the bandwidth is tight, the traffic is controlled by the application to realize the minimum necessary communication. The present embodiment is characterized in that the application changes the traffic for the application-linked QoS control. Further, the present embodiment is characterized in that the terminal performs the traffic switching for application-linked QoS control.

Further, the present embodiment is characterized in that channel access admission control is implemented. For example, the present embodiment is characterized in that when QoS control is required, such as when the band or the like is tight, or when the band or the like is tight, channel access is restricted such that the transmission right is not granted.

### 3.1. QoS Control for Terminal Group

First, the QoS control for the terminal group according to the embodiment of the present disclosure will be described. In the embodiment, the concept of group priority is introduced into the terminal group. Group priority defines the priority level of a group. This group priority may be used for priority control between groups. The group priority is made to be known from the group ID given to the terminal group. For example, when the group ID is given as xxxyyyy, the group ID may be defined such that xxx is the priority and yyyy is the actual group ID.

All packets transmitted in a specific group may be operated with the same group priority. Furthermore, the priority of the transmission packet may be weighted by the group priority.

The terminal device may determine the priority at the time of packet transmission by using at least one of the group ID, the group priority, and the transmission packet priority. By including the priority at the time of packet transmission in SCI and transmitting it, the terminal device can control the packet priority with the peripheral terminal device. Specifically, in the sensing operation, it is possible to exclude the resource by comparing the priority of its own transmission packet with the priority of the packet of which the other terminal makes notification using SCI. For example, it is possible to protect a resource in which a packet having a higher priority than its own packet is transmitted without using it.

A specific example will be described. The method of calculating the priority at the time of transmission using the group priority when the group ID is five, the group priority is two (the smaller the number is the higher the priority), and the transmission packet priority is set to four is illustrated. For example, the group priority (=two) is obtained from the group ID, and the terminal device uses the group priority as it is as the priority (=two) at the time of transmission.

Further, in the same case, a method of calculating the priority at the time of transmission by multiplying the weight by the group priority using the group priority and the priority at the time of transmission is illustrated. The terminal device uses two obtained by multiplying the transmission packet priority (=four) by 1/the group priority (=two) as the transmission priority (=two).

The comparison table between the group priority and the terminal priority is pre-configured in the terminal device, or is configured in it from the base station. This comparison table is a table specifying which is prioritized, for example, when the terminal device of group priority A transmits a packet with packet priority B or when the terminal device of terminal priority C transmits a packet with packet priority D. In such a case, it is possible to determine which is prioritized by the magnitude of the value obtained by multiplying the priority of the terminal device by the priority of the packet. The table for this determination is configured in the terminal device.

The terminal device can change the resource pool, the bandwidth, and the bandwidth part (BWP) according to the group priority or the group ID. That is, the terminal device can impose access restrictions on the resource pool, the bandwidth, and the BWP by the group priority or the group ID.

The terminal device can also switch the HARQ feedback mode according to the group priority or the group ID. The HARQ feedback mode has a mode in which NACK-based feedback is performed and a mode in which ACK/NACK-based feedback is performed. The mode in which NACK-based feedback is performed is a mode in which the transmission terminal performs retransmission when even one NACK is transmitted from the terminal device of the group. The mode in which feedback of ACK/NACK-based feedback is performed is a mode in which when the transmission terminal receives ACK/NACK from the terminal device of the group, and there is no NACK or feedback, the transmission terminal performs retransmission and when all the terminal devices of the group transmit ACK, the transmission terminal does not perform retransmission. At the time of this switching, the terminal device uses the group ID. Further, the information included in, linked to, or accompanying the group ID may include a group priority, the number of terminal devices (reception terminals) that receive the packet, a packet priority, a service priority, and the number of feedback terminal devices.

Further, the terminal device can switch the HARQ feedback method according to the group priority or the group ID. HARQ feedback methods include dynamic feedback and semi-static feedback. The dynamic feedback is a method of transmitting HARQ feedback for each packet transmission. For example, as in PUCCH format 0, it is a method of providing feedback immediately after packet transmission. The feedback in this case may be feedback using a sequence. The semi-static feedback is a method of being capable of providing feedback for a plurality of packet transmissions at once, and is a bit-level feedback method.

The terminal device can also determine a terminal device that executes the HARQ feedback method according to the group priority or the group ID. The terminal device that executes the HARQ feedback method may be randomly determined or may be sequentially determined from within the group. When the group is divided into a plurality of subgroups, the terminal device may determine all the terminal devices included in each subgroup as the terminal device that executes the HARQ feedback method.

Further, the terminal device can switch the power control mode according to the group priority or the group ID. There are two types of power control modes: Open loop power control and Closed loop power control. At the time of this switching, it is also possible to change the control parameters of the power control.

Further, the terminal device can change the transmission power according to the group priority or the group ID. In addition, the terminal device can change the transmission mode according to the group priority or the group ID.

In addition, the terminal device can change the channel quality indicator (CQI) and the modulation and coding scheme (MCS) according to the group priority or the group ID. That is, the terminal device changes the CQI table or the MCS table according to the group priority or the group ID. This change may be made by restricting the existing table, or a new table may be defined for the group.

The required shortest communication distance (Minimum distance requirement) is derived from the level of group priority, which may change the transmission parameters of the physical layer. That is, the transmission parameters of the physical layer may be changed depending on the magnitude of the required shortest communication distance.

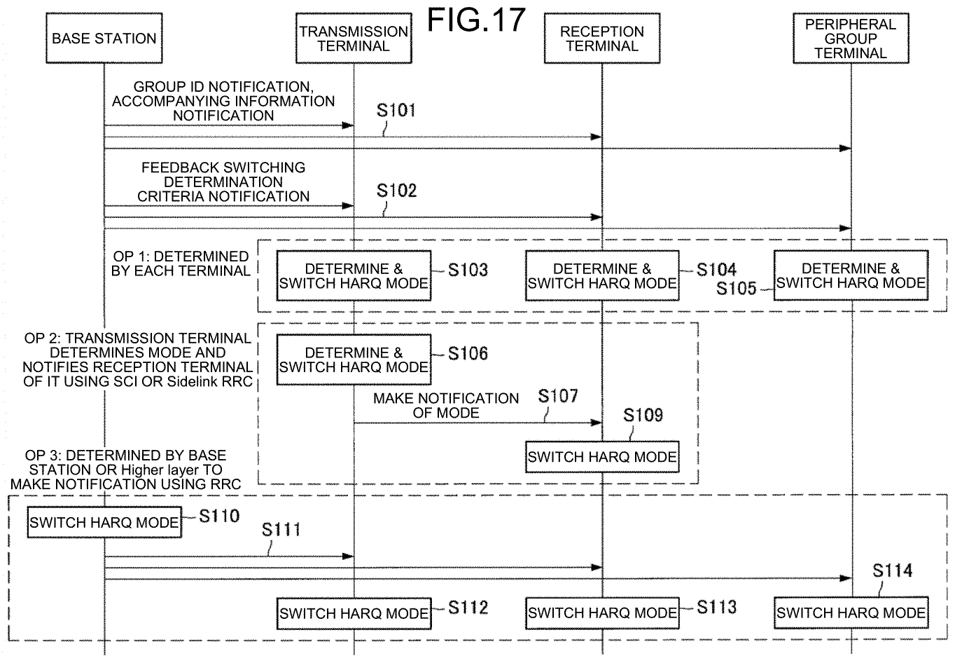

FIG. 17 is a flow chart illustrating an operation example of the communication system according to the embodiment of the present disclosure. FIG. 17 illustrates the operations of the base station, and the transmission terminal, the reception terminal, and the peripheral group terminal that perform side link communication. The transmission terminal, the reception terminal, and the peripheral group terminal form one terminal group.

The base station 100 notifies each terminal of the terminal group of the group ID obtained from the upper layer (Step S101). The base station 100 makes notification using radio resource control (RRC) signaling.

As necessary, the base station 100 may notify, as accompanying information, each terminal of the terminal group of the number of terminals in the group, the number of reception terminals in the group, the number of terminals capable of providing feedback (when only some terminals provide HARQ feedback), the maximum number of terminals capable of providing feedback, the minimum number of terminals capable of providing feedback (minimum number of terminal devices that surely perform feedback), the group priority, the service priority, the priority at the time of packet transmission, the bandwidth congestion (CBR: Channel Busy Ratio), the channel occupancy ratio (CR), and the like. The bandwidth congestion and the CR parameters may be measured by the terminal device. When the measurement is made by the terminal device, the base station may give a measurement configuration to the terminal device.

Subsequently, the base station 100 notifies each terminal of the terminal group of the determination to switch the feedback and the criteria (Step S102).

Here, as the operation of each terminal device, three examples are illustrated in FIG. 17. In the first example (OP1), each terminal device determines and switches the HARQ mode (Steps S103, S104, S105). That is, each terminal device determines the HARQ mode using the above information obtained from the base station 100.

In the next example (OP2), the transmission terminal determines the mode (Step S106) and notifies the reception terminal of it using sidelink RRC signaling or SCI (Step S107). The reception terminal switches the HARQ mode based on the mode determined by the transmission terminal (Step S109).

In the next example (OP3), the base station 100 determines the mode (Step S110) and notifies each terminal device of the group of it using RRC signaling (Step S111). Each terminal device in the group switches the HARQ mode based on the mode determined by the base station 100 (Steps S112, S113, S114). The terminal device 200 may rewrite the HARQ mode allocation determined by the base station 100 by itself according to the conditions. In this case, as the condition setting, for example, the traffic type of the terminal device 200 and the radio communication environment information of the side link (for example, the band measurement result, CBR, and the like) can be used when the terminal device makes a determination. The base station 100 may notify the terminal device 200 of the rewriting condition by using RRC signaling or the like, or may be pre-configured in the terminal device.

In FIG. 17, what is changed in determining and switching the HARQ mode is the HARQ feedback mode and the resource setting in the HARQ feedback.

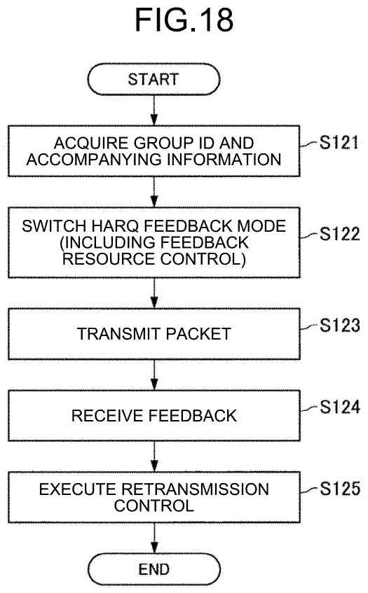

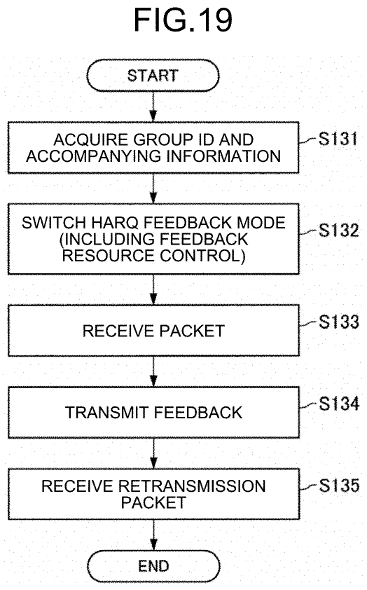

A specific operation example will be described. Here, switching an HARQ mode by the number of reception terminals and CBR will be described. FIG. 18 is a flow chart illustrating an operation example of the transmission terminal, and FIG. 19 is a flow chart illustrating an operation example of the reception terminal.

The terminal device (transmission terminal and reception terminal) acquires the group ID and accompanying information from the base station 100 (Steps S121, S131). It is assumed that the transmission terminal belongs to the group 5. The base station also makes notification of the number of group terminals as a switching criterion included in the accompanying information. At the time of packet transmission, the transmission terminal determines and switches the HARQ mode using OP2 as the operation example illustrated in FIG. 17.

First, when the transmission terminal checks the number of terminals in the terminal group to determine the mode, the number is 20. When the number of group terminals is 15 or more, the number of terminals is too large, so that it is required to perform the NACK-based HARQ to reduce the overhead during feedback. In addition, the terminal device measures CBR and has found that the bandwidth is very congested because CBR=0.5. When the bandwidth is congested, it is necessary to reduce the overhead, so that the ACK/NACK-based HARQ feedback is stopped and the NACK-based HARQ feedback is required. Since the number of group terminals is 15 or more and the CBR is 0.5 or more, the transmission terminal sets the feedback mode to a mode in which NACK-based feedback is performed using this information and performs switching (Step S122).

The transmission terminal notifies the reception terminal of the mode in which NACK-based feedback is performed using SCI. Upon receiving the notification from the transmission terminal, the reception terminal also switches to the mode in which NACK-based feedback is performed (Step S132). In addition, the transmission terminal determines dynamic resource feedback as a feedback resource setting, and notifies the reception terminal of the switch to dynamic feedback using SCI.

The transmission terminal then transmits the packet (Step S123). When the reception terminal receives the packet from the transmission terminal (Step S133), the reception terminal performs ACK/NACK in the specified HARQ mode and feedback method according to the reception status (Step S134). The transmission terminal receives the feedback from the reception terminal (Step S124), and performs retransmission control based on the feedback (Step S125). When the packet is required to be retransmitted, the transmission terminal retransmits the packet. The reception terminal receives the packet retransmitted from the transmission terminal (Step S135) and gives feedback as necessary.

### 3.2. Application-Linked QoS Control

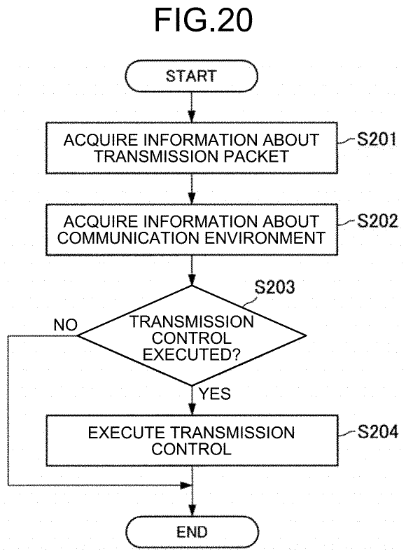

Subsequently, the application-linked QoS control according to the embodiment of the present disclosure will be described. First, an outline of application-linked QoS control according to the embodiment of the present disclosure will be described. FIG. 20 is a flow chart illustrating an outline of application-linked QoS control according to the embodiment of the present disclosure.

The terminal device 200 (transmission terminal) that intends to transmit the packet first acquires information about the transmission packet from the application layer (Step S201). Subsequently, the transmission terminal acquires information about the communication environment (Step S202). Subsequently, the transmission terminal makes a transmission control execution determination (Step S203). Subsequently, the transmission terminal executes transmission control as necessary (Step S204).

Each operation will be described in detail below. First, obtaining information about the transmission packet from the application layer will be described.

The transmission terminal acquires, as information about the transmission packet from the application layer, the information such as packet request QoS, reliability, delay, traffic type (unicast, groupcast, broadcast), minimum communication request range, target communication area, request data rate, transmission frequency (retransmission, repeated transmission), payload size, packet size statistics, packet arrival time statistics, 5G QoS indicator (5QI) set of QoS, resource type used (non-GBR, GBR, delay-critical GBR), and maximum data burst volume (MDBV).

Next, the acquisition of information about the communication environment will be described.

As information about the communication environment, the transmission terminal, by measurement, acquires the information such as CBR, CR, RSRP/RSSI/RSRQ, CQI, synchronization-related information (how much synchronization signal is transmitted, what kind of terminal device exists in the vicinity, and the like), the location of a peripheral terminal and the transmission power of the peripheral terminal, the ACK/NACK ratio, the block error rate (BLER), the packet reception ratio (PRR), the packet inter-reception (PIR), the packet loss ratio, and the packet delay measurement (packet delay).

In addition, in the transmission terminal, the configuration for measuring information about the communication environment may be pre-configured, or may be configured by using RRC signaling from the base station 100 or the peripheral terminal (RSU, and the like). The configuration for measuring the information about the communication environment may include the measurement target, the measurement interval, the measurement cycle, the timing of reporting to the base station 100, and the like.

The above-mentioned information about the communication environment may be acquired by the own device performing sensing, or notification of the information may be made by a third party terminal device or infrastructure. Notification of the information that is sensed and measured by a third party terminal or infrastructure may be made, or notification of the information may be made by the base station or the RSU to the terminal device. In addition, notification of the information may be made by a terminal device that locally plays the role of a leader, such as a Master UE or a Group leader UE. The terminal or infrastructure that performs the measurement performs the measurement at the configuration timing for pre-configured measurement or measurement timing that is configured by the base station. Similarly, when the reporting timing to the base station 100 is configured, the terminal device that performed measurement transmits the measurement result to a peripheral vehicle or the base station.

Subsequently, the transmission control execution determination will be described.

The transmission control execution determination is performed using any one or a plurality of information about the transmission packet, information about the transmission terminal (terminal priority, terminal group priority, and the like), and information about the communication environment. The transmission control execution determination may be made in packet unit. That is, the terminal device may perform transmission control execution determination for the specific QoS packet and perform transmission control. The transmission control execution determination may be made relatively. For example, a transmission control execution determination may be made such that packets having a predetermined QoS level or higher are not controlled.

There can be two types of transmission control execution determination: (a) the execution determination by the terminal device, and (b) the execution determination by the base station or the infrastructure. When the terminal device side makes a transmission control execution determination, it receives, from the base station or the infrastructure, the information necessary for the transmission control execution determination. The instruction may be given in notification by using RRC signaling or may be pre-configured to the terminal device. When the base station or the infrastructure makes a transmission control execution determination, the terminal device executes the transmission control by receiving an instruction by the base station or the infra infrastructure of the transmission control execution determination result. The instruction is given in notification to the terminal device by using RRC signaling or DCI.

Next, transmission control execution will be described.

In the present embodiment, transmission control is executed by three operations of (a) transmission parameter restriction, (b) channel access restriction (Admission control), and (c) traffic adjustment.

First, the transmission parameter restriction will be described. The terminal device can perform, as transmission parameters, transmission power and upper limit of transmission power, MCS range and MCS, the number of repetitions, whether HARQ can be performed, the number of retransmissions, repetition transmission, HARQ transmission switching, MIMO transmission, a plurality of antenna transmissions, change in transmission resource, frequency switching, Contiguous transmission switching (switching to transmission using continuous resource allocation on the frequency when discontinuous transmission is performed on the frequency), and the like.

Next, the channel access restriction will be described. As the channel access restriction, the terminal device may perform restriction not to give transmission permission in a specific resource pool or frequency band. This restriction may be made based on the notification from the base station. The terminal device may prohibit access to its resource and channels as well as transmission permission. The terminal device may also prohibit sensing. The terminal device may restrict the selected resource at the time of resource selection. For example, it may change the resource to be excluded in the resource exclusion process in the sensing procedure (Mode 2) in the terminal device. In this case, the terminal device may exclude packets with a particular QoS level. Further, in this case, the terminal device may change the threshold value for exclusion (threshold value for exclusion of transmission candidate resources in sensing).

Next, the traffic adjustment will be described. As the traffic adjustment, the terminal device issues a traffic adjustment request to the application layer and requests that the data rate be lowered (for example, capability information of the physical layer, CBR, OR, and the like).

Further, as the traffic adjustment, the terminal device performs transmission with the traffic in which the data rate can be changed. For example, the terminal device generates traffic from a plurality of packets. The plurality of packets is defined as a basic packet and a redundant packet. The basic packet contains the data to be given in notification at least. The basic packet and the redundant packet are mixed to form one packet. When the communication control is executed, the terminal device transmits only the basic packet, and performs transmission so that the redundant packet portion is discarded. The basic packet and the redundant packet may be composed of a plurality of levels. Then, the amount of redundant packets to be included may be changed according to the level of communication control. For example, when the level is one, only the basic packet is included, and as the level goes up, the redundant packets may increase. The basic packet conveys the minimum amount of information, which may be, for example, coarse image data or information extracting only feature points.

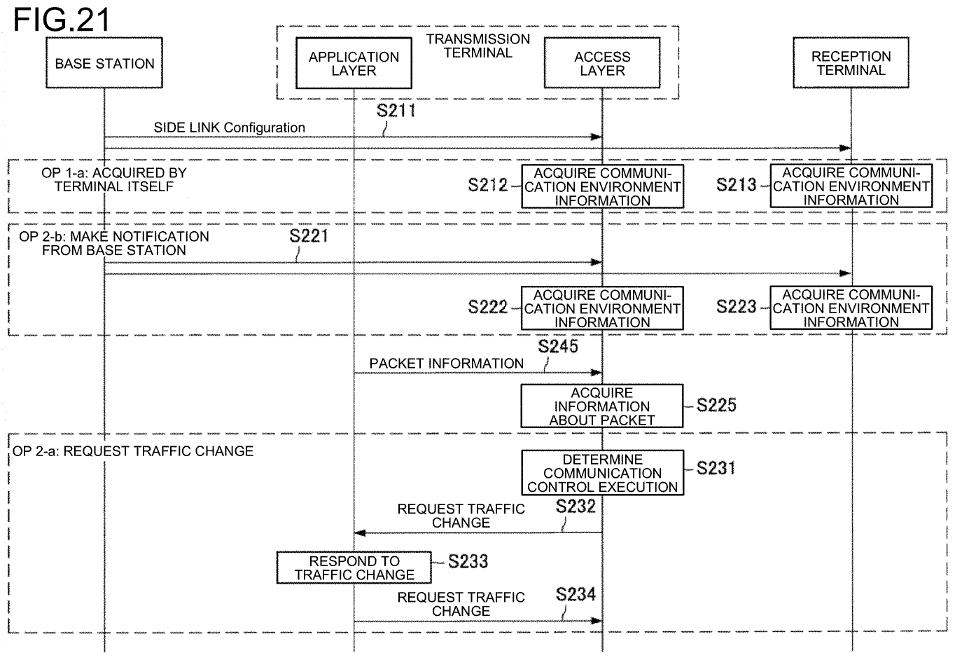

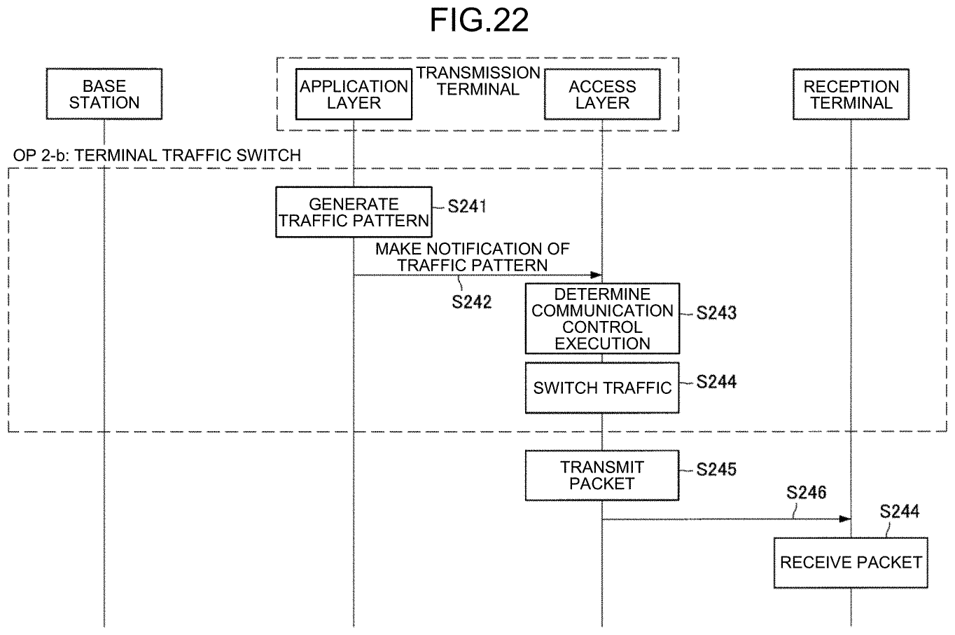

FIGS. 21 and 22 are flow charts for explaining the application-linked QoS control according to the embodiment of the present disclosure. FIGS. 21 and 22 illustrate the operations of the base station 100, the transmission terminal, and the reception terminal. The operation of the transmission terminal is illustrated separately for the application layer and the access layer.

First, the base station notifies each terminal device of the configuration for side link communication (Step S211).

After that, each terminal device acquires communication environment information. FIG. 21 illustrates two examples of acquiring communication environment information. In the first example, each terminal device acquires communication environment information by itself (Steps S212, S213). In the second example, the base station makes notification of the configuration for measuring the information about communication environment (Step S221), and each terminal device acquires the communication environment information based on the configuration (Steps S222, S223).

The transmission terminal then acquires information about the transmission packet from the application layer. The application layer of the transmission terminal transmits information about the transmission packet to the access layer (Step S224), and the access layer of the transmission terminal acquires the information about the transmission packet transmitted from the application layer (Step S224).

Subsequently, the transmission terminal executes a communication control execution determination, and executes transmission control based on the determination. Two examples are illustrated in FIGS. 21 and 22. In the first example, the access layer of the transmission terminal makes a communication control execution determination (Step S231), and the access layer of the transmission terminal requests the application layer to change the traffic (Step S232). The application layer of the transmission terminal responds to the traffic change (Step S233) and requests the access layer to change the traffic according to the traffic change at the application layer (Step S234).

In the second example, the application layer of the transmission terminal first generates a traffic pattern (Step S241) and notifies the access layer of the generated traffic pattern (Step S242). Subsequently, the access layer of the transmission terminal makes a communication control execution determination (Step S243), and switches the traffic based on the result of the communication control execution determination (Step S244).

The transmission terminal makes a communication control execution determination, and when the traffic is switched, the transmission terminal executes packet transmission by the switched traffic (Step S245). The packet is transmitted from the transmission terminal to the reception terminal (Step S246), and the reception terminal receives the packet from the transmission terminal (Step S247).

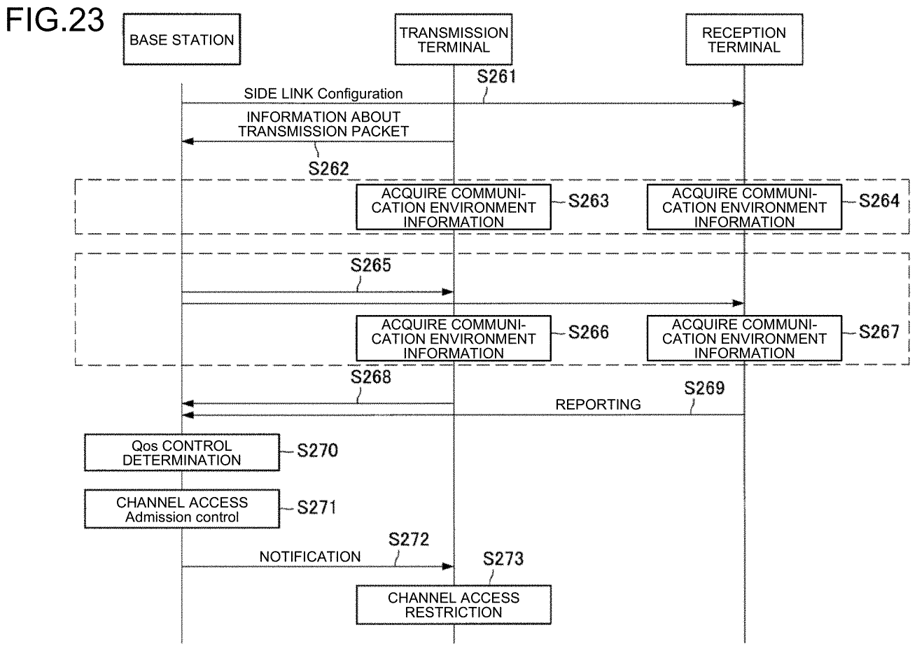

FIG. 23 is a flow chart illustrating a channel access restriction (Admission control) in the application-linked QoS control according to the embodiment of the present disclosure.

First, the base station notifies each terminal device of the configuration for side link communication (Step S261). Subsequently, the transmission terminal notifies the base station of information about the transmission packet (Step S262). After that, each terminal device acquires communication environment information. FIG. 23 illustrates two examples of acquiring communication environment information. In the first example, each terminal device acquires communication environment information by itself (Steps S263, S264). In the second example, the base station makes notification of the configuration for measuring the information about communication environment (Step S265), and each terminal device acquires the communication environment information based on the configuration (Steps S266, S267).

When the terminal device acquires the communication environment information, it executes reporting of the communication environment information to the base station (Steps S268, S269). The base station makes the QoS control determination based on the content of the reporting (Step S270). Then, the base station executes channel access admission control based on the result of the QoS control determination (Step S271), and notifies the transmission terminal of the content (Step S272). The transmission terminal executes channel access restriction based on the notification from the base station (Step S273).

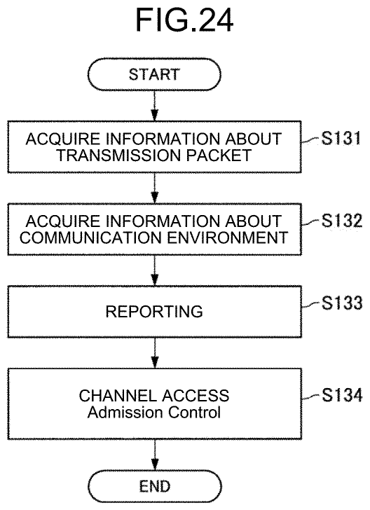

FIG. 24 is a flow chart for explaining channel access restrictions in the application-linked QoS control according to the embodiment of the present disclosure, and is a flow chart focusing on the operation at the transmission terminal.

The transmission terminal first acquires information about the transmission packet from the application layer (Step S281). The transmission terminal then acquires information about the communication environment (Step S282). Subsequently, the transmission terminal performs reporting to the base station (Step S283). Subsequently, the transmission terminal performs channel access admission control based on the notification from the base station (Step S284).

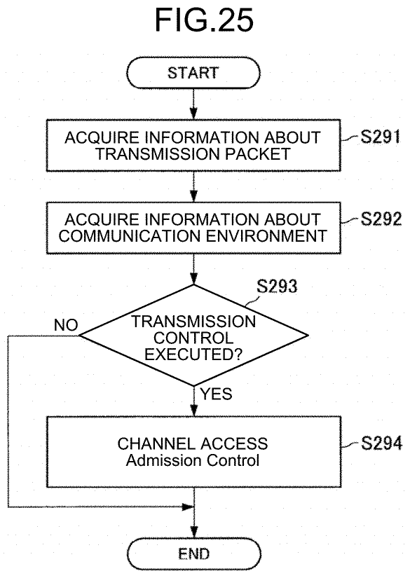

FIG. 25 is a flow chart for explaining the channel access restriction in the application-linked QoS control according to the embodiment of the present disclosure, and is a flow chart focusing on the operation at the base station.

The base station first acquires information about the transmission packet from the transmission terminal (Step S291). The base station then acquires information about the communication environment (Step S292). Subsequently, the base station determines whether to execute transmission control based on the reporting from the terminal device (Step S293). Subsequently, the base station performs channel access admission control when it is necessary to execute transmission control (Step S294).

A specific use case of application-linked QoS control according to the embodiment of the present disclosure will be described.

(Traffic Change)

First, an example of a use case of a traffic change will be described. The terminal device acquires information about the transmission packet from the application layer. Here, the terminal device obtained the request QoS level of the transmission packet. The QoS level was six out of eight (assuming one is the smallest and eight is the largest).

Next, in order to acquire information about the communication environment, the terminal device was made to set a measurement configuration of a measurement method from the base station, and obtained CBR and PRR information.

Next, the terminal device makes a transmission control execution determination. The method of determining transmission control execution was set in the terminal by using RRC signaling from the base station. The setting was that when the bandwidth congestion level obtained from CBR was 50% or more and the PRR was 70% or less, transmission control was performed on a packet with QoS level of 7 or less. As a result of measurement, the terminal device was found to have a congestion level of 60% and a PRR of 60%. Since the QoS level of the transmission packet is six, the terminal device has decided to execute transmission control.

The transmission control here was to stop HARQ transmission and repeatedly transmit twice as a transmission parameter adjustment. In addition, since the transmission resource was restricted, the terminal device was required to adjust the traffic. The terminal device issued a traffic adjustment request to the application layer to reduce the traffic volume. As a result, the traffic reduced redundant information and included only the minimum required information. The terminal device transmitted the restricted traffic with the adjusted transmission parameters.

(Channel Access Admission Control)

Next, a use case example of channel access admission control will be described. The terminal device acquires information about the transmission packet from the application layer. Here, the terminal device obtained the request QoS level of the transmission packet. The QoS level was six out of eight (assuming one is the smallest and eight is the largest).

Next, in order to acquire information about the communication environment, the terminal device was made to set a measurement configuration of a measurement method from the base station, and obtained CBR and PRR information.

Next, the terminal device makes a transmission control execution determination. The method of determining transmission control execution was set in the terminal by using RRC signaling from the base station. The setting is that when the bandwidth congestion level obtained from CBR is 50% or more and PRR is 70% or less, a packet with QoS level of 7 or less cannot be transmitted in the set resource pool A. As a result of measurement, the terminal device is found to have a congestion level of 60% and a PRR of 60%. Since the QoS level of the transmission packet is six, the terminal device loses the right to access the target resource and cannot perform the sensing and transmission operations. Therefore, the terminal device searches for a new channel-accessible band to transmit the packet in that band.

Of course, the use cases mentioned here are just examples, and the terminal device 200 can make various transmission control execution determinations based on information obtained by its own device performing sensing, information transmitted from the base station 100, and information transmitted from another communication device 200 existing in the vicinity. Then, the communication device 200 can execute various transmission controls by using the result of the transmission control execution determination.

### 4. APPLICATION EXAMPLE

The technology according to the present disclosure can be applied to various products. For example, the base station 100 may be realized as any kind of evolved Node B (eNB) such as a macro eNB or a small eNB. The small eNB may be an eNB that covers a cell smaller than the macro cell, such as a pico eNB, a micro eNB, or a home (femto) eNB. Instead, the base station 100 may be realized as another type of base station such as a Node B or a base transceiver station (BTS). The base station 100 may include a main body (also referred to as a base station device) that controls radio communication, and one or a plurality of remote radio heads (RRHs) that are disposed at a location different from the main body. Further, various types of terminals, which will be described later, may operate as the base station 100 by temporarily or semi-permanently executing the base station function.

Further, for example, the terminal device 200 may be realized as a mobile terminal such as a smartphone, a tablet personal computer (PC), a notebook PC, a portable game terminal, a portable/dongle type mobile router or a digital camera, or an in-vehicle terminal such as a car navigation device. Further, the terminal device 200 may be realized as a terminal (also referred to as a machine type communication (MTC) terminal) that performs machine to machine (M2M) communication. Further, the terminal device 200 may be a radio communication module (for example, an integrated circuit module composed of one base station 100) mounted on these terminals.

### 4.1. Application Example Related to Base Stations

### First Application Example

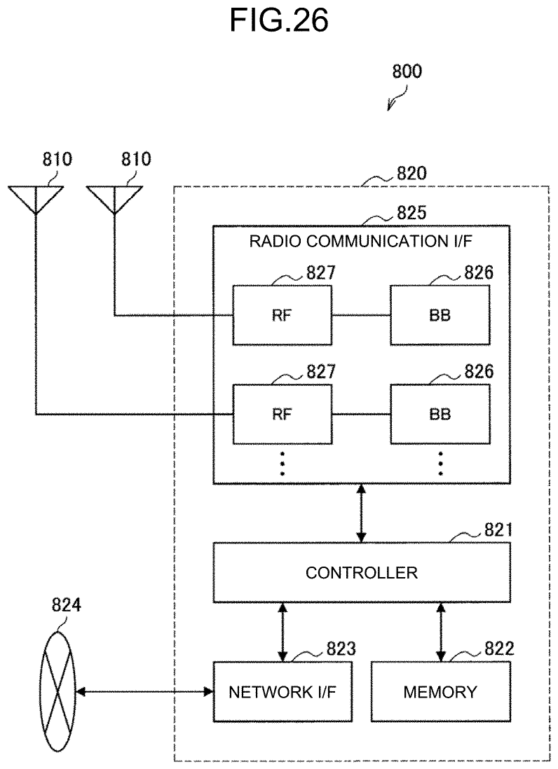

FIG. 26 is a block diagram illustrating a first example of a schematic configuration of an eNB to which the technique according to the present disclosure can be applied. An eNB 800 includes one or a plurality of antennas 810 and a base station device 820. Each antenna 810 and base station device 820 may be connected to each other via an RF cable.

Each of the antennas 810 has a single or a plurality of antenna elements (for example, a plurality of antenna elements constituting a MIMO antenna) and is used for transmission and reception of radio signals by the base station device 820. The eNB 800 may include a plurality of antennas 810 as illustrated in FIG. 26, and the plurality of antennas 810 may respectively correspond to a plurality of frequency bands used by, for example, the eNB 800. Although FIG. 26 illustrates an example in which the eNB 800 includes a plurality of antennas 810, the eNB 800 may include a single antenna 810.

The base station device 820 includes a controller 821, a memory 822, a network interface 823, and a radio communication interface 825.

The controller 821 may be, for example, a CPU or a DSP and operates various functions of the upper layer of the base station device 820. For example, the controller 821 generates a data packet from the data in the signal processed by the radio communication interface 825 to transfer the generated packet via the network interface 823. The controller 821 may generate a bundled packet by bundling data from a plurality of baseband processors to transfer the generated bundled packet. In addition, the controller 821 may have a logic function that executes control such as radio resource control, radio bearer control, mobility management, admission Control, or scheduling. Further, the control may be executed in cooperation with the peripheral eNB or the core network node. The memory 822 includes a RAM and a ROM to store a program executed by the controller 821 and various control data (for example, terminal list, transmission power data, scheduling data, and the like).

The network interface 823 is a communication interface for connecting the base station device 820 to a core network 824. The controller 821 may communicate with the core network node or another eNB via the network interface 823. In this case, the eNB 800 and the core network node or another eNB may be connected to each other by a logical interface (for example, S1 interface or X2 interface). The network interface 823 may be a wired communication interface or a radio communication interface for a radio backhaul. When the network interface 823 is a radio communication interface, the network interface 823 may use a frequency band for radio communication higher than the frequency band used by the radio communication interface 825.

The radio communication interface 825 supports a cellular communication system such as a long term evolution (LTE) or an LTE-advanced, and provides a radio connection to a terminal located in the cell of the eNB 800 via the antenna 810. The radio communication interface 825 may typically include a baseband (BB) processor 826, an RF circuit 827, and the like. The BB processor 826 may perform, for example, coding/decoding, modulation/demodulation, and multiplexing/demultiplexing, and performs various signal processes of each layer (for example, an L1, a medium access control (MAC), a radio link control (RLC), and a packet data convergence protocol (PDCP)). The BB processor 826 may have some or all of the above-mentioned logical functions instead of the controller 821. The BB processor 826 may be a module including a memory that stores a communication control program, a processor that executes the program, and related circuits, and the functions of the BB processor 826 may be changed by updating the above program. Further, the module may be a card or a blade inserted into the slot of the base station device 820, or may be a chip mounted on the card or the blade. On the other hand, the RF circuit 827 may include a mixer, a filter, an amplifier, and the like to transmit and receive radio signals via the antenna 810.

The radio communication interface 825 may include a plurality of BB processors 826 as illustrated in FIG. 26, and the plurality of BB processors 826 may respectively correspond to a plurality of frequency bands used by, for example, the eNB 800. Further, the radio communication interface 825 may include a plurality of RF circuits 827 as illustrated in FIG. 26, and the plurality of RF circuits 827 may respectively correspond to, for example, a plurality of antenna elements. Note that FIG. 26 illustrates an example in which the radio communication interface 825 includes a plurality of BB processors 826 and a plurality of RF circuits 827, but the radio communication interface 825 may include a single BB processor 826 or a single RF circuit 827.

In the eNB 800 illustrated in FIG. 26, one or a plurality of components included in the base station 100 described with reference to FIG. 2 (for example, at least one of the communication control unit 151, the information acquisition unit 153, and the notification unit 155) may be mounted in radio communication interface 825. Alternatively, at least some of these components may be mounted in controller 821. As an example, the eNB 800 is equipped with a module including part (for example, the BB processor 826) or all of the radio communication interface 825 and/or the controller 821, and the one or the plurality of components may be mounted in the module. In this case, the module may store a program for causing the processor to function as the one or the plurality of components (in other words, a program for causing the processor to perform the operation of the one or the plurality of components) to execute the program. As another example, a program for causing the processor to function as the one or the plurality of components may be installed in the eNB 800 and the radio communication interface 825 (for example, the BB processor 826) and/or the controller 821 may execute the program. As described above, the eNB 800, the base station device 820, or the module may be provided as a device including the one or the plurality of components, and a program for causing the processor to function as the one or the plurality of components may be provided. Further, a readable recording medium on which the above program is recorded may be provided.

Further, in the eNB 800 illustrated in FIG. 26, the radio communication unit 120 described with reference to FIG. 2 may be mounted in the radio communication interface 825 (for example, the RF circuit 827). Further, the antenna unit 110 may be mounted in the antenna 810. Further, the network communication unit 130 may be mounted in the controller 821 and/or the network interface 823. Further, the storage unit 140 may be mounted in the memory 822.

### Second Application Example

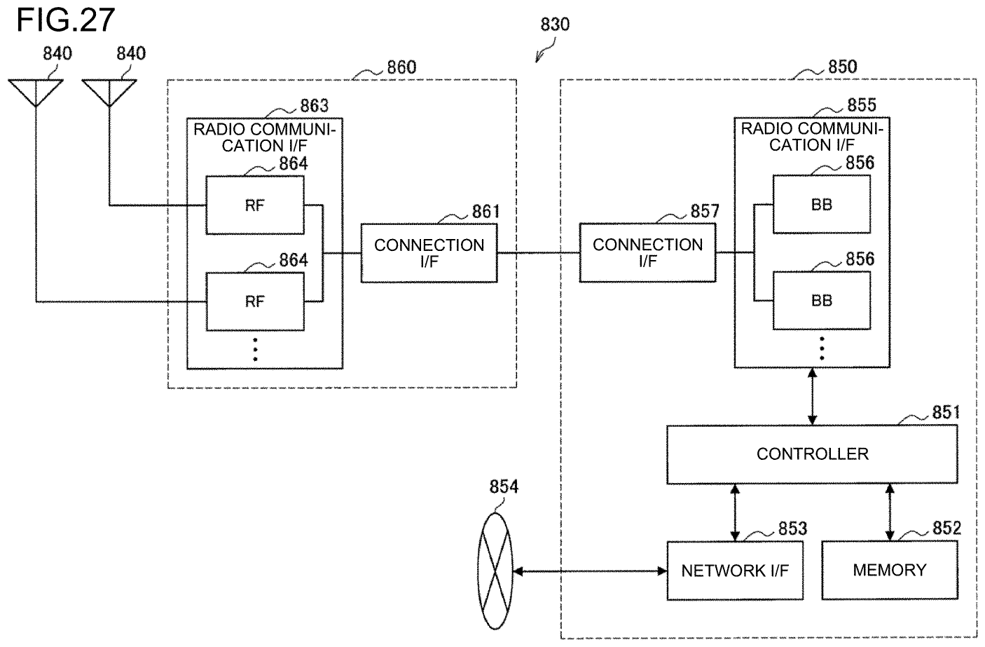

FIG. 27 is a block diagram illustrating a second example of a schematic configuration of an eNB to which the technique according to the present disclosure can be applied. An eNB 830 includes one or a plurality of antennas 840, a base station device 850, and an RRH 860. Each antenna 840 and the RRH 860 may be connected to each other via the RF cable. Further, the base station device 850 and the RRH 860 can be connected to each other by a high-speed line such as an optical fiber cable.

Each of the antennas 840 has a single or a plurality of antenna elements (for example, a plurality of antenna elements constituting a MIMO antenna) and is used for transmitting and receiving radio signals by the RRH 860. The eNB 830 may include a plurality of antennas 840 as illustrated in FIG. 27, and the plurality of antennas 840 may respectively correspond to a plurality of frequency bands used by, for example, the eNB 830. Although FIG. 27 illustrates an example in which the eNB 830 includes a plurality of antennas 840, the eNB 830 may include a single antenna 840.

The base station device 850 includes a controller 851, a memory 852, a network interface 853, a radio communication interface 855, and a connection interface 857. The controller 851, memory 852, and network interface 853 are similar to the controller 821, memory 822, and network interface 823 described with reference to FIG. 26.

The radio communication interface 855 supports a cellular communication system such as an LTE or an LTE-advanced, and provides a radio connection to terminals located in the sector corresponding to the RRH 860 via the RRH 860 and the antenna 840. The radio communication interface 855 may typically include a BB processor 856 and the like. The BB processor 856 is similar to the BB processor 826 described with reference to FIG. 26, except that it is connected to an RF circuit 864 of the RRH 860 via the connection interface 857. The radio communication interface 855 may include a plurality of BB processors 856 as illustrated in FIG. 27, and the plurality of BB processors 856 may respectively correspond to a plurality of frequency bands used by, for example, the eNB 830. Although FIG. 27 illustrates an example in which the radio communication interface 855 includes a plurality of BB processors 856, the radio communication interface 855 may include a single BB processor 856.

The connection interface 857 is an interface for connecting the base station device 850 (the radio communication interface 855) to the RRH 860. The connection interface 857 may be a communication module for communication on the high-speed line that connects the base station device 850 (radio communication interface 855) and the RRH 860.

The RRH 860 also includes a connection interface 861 and a radio communication interface 863.

The connection interface 861 is an interface for connecting the RRH 860 (the radio communication interface 863) to the base station device 850. The connection interface 861 may be a communication module for communication on the high-speed line.

The radio communication interface 863 transmits and receives radio signals via the antenna 840. The radio communication interface 863 may typically include the RF circuit 864 and the like. The RF circuit 864 may include a mixer, a filter, an amplifier, and the like to transmit and receive radio signals via the antenna 840. As illustrated in FIG. 27, the radio communication interface 863 may include a plurality of RF circuits 864, and the plurality of RF circuits 864 may respectively correspond to, for example, a plurality of antenna elements. Although FIG. 27 illustrates an example in which the radio communication interface 863 includes a plurality of RF circuits 864, the radio communication interface 863 may include a single RF circuit 864.

In the eNB 830 illustrated in FIG. 27, one or a plurality of components included in the base station 100 described with reference to FIG. 2 (for example, at least one of the communication control unit 151, the information acquisition unit 153, and the notification unit 155) may be mounted in the radio communication interface 855 and/or the radio communication interface 863. Alternatively, at least some of these components may be mounted in controller 851. As an example, the eNB 830 may include a module including part (for example, the BB processor 856) or all of the radio communication interface 855 and/or the controller 851, and the one or the plurality of components may be mounted in the module. In this case, the module may store a program for causing the processor to function as the one or the plurality of components (in other words, a program for causing the processor to perform the operation of the one or the plurality of components) to execute the program. As another example, a program for causing the processor to function as the one or the plurality of components may be installed in the eNB 830, and the radio communication interface 855 (for example, the BB processor 856) and/or the controller 851 may execute the program. As described above, the eNB 830, the base station device 850, or the module may be provided as a device including the one or the plurality of components, and a program for causing the processor to function as the one or the plurality of components may be provided. Further, a readable recording medium on which the above program is recorded may be provided.

Further, in the eNB 830 illustrated in FIG. 27, for example, the radio communication unit 120 described with reference to FIG. 2 may be mounted in the radio communication interface 863 (for example, the RF circuit 864). Further, the antenna unit 110 may be mounted in the antenna 840. Further, the network communication unit 130 may be mounted in the controller 851 and/or the network interface 853. Further, the storage unit 140 may be mounted in the memory 852.

### 4.2. Application Example Related to Terminal Devices

### First Application Example

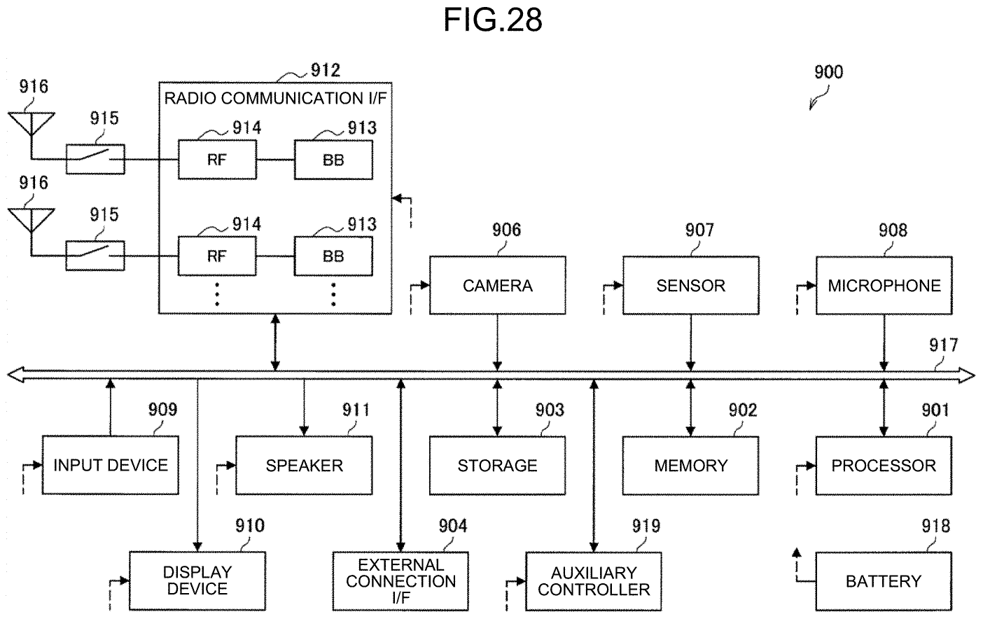

FIG. 28 is a block diagram illustrating an example of a schematic configuration of a smartphone 900 to which the technique according to the present disclosure can be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or a plurality of antenna switches 915, one or a plurality of antennas 916, a bus 917, a battery 918, and an auxiliary controller 919.

The processor 901 may be, for example, a CPU or a system on chip (SoC), and controls the functions of the application layer and other layers of the smartphone 900. The memory 902 includes a RAM and a ROM, and stores programs executed by the processor 901 and data. The storage 903 may include a storage medium such as a semiconductor memory or a hard disk. The external connection interface 904 is an interface for connecting an external device such as a memory card or a Universal Serial Bus (USB) device to the smartphone 900.

The camera 906 has an image pickup device such as a charge coupled device (CCD) or a complementary metal oxide semiconductor (CMOS) to generate a pickup image. The sensor 907 may include, for example, a group of sensors such as a positioning sensor, a gyro sensor, a geomagnetic sensor, and an acceleration sensor. The microphone 908 converts the voice input to the smartphone 900 into a voice signal. The input device 909 includes, for example, a touch sensor that detects a touch on the screen of the display device 910, a keypad, a keyboard, a button, or a switch, and receives an operation or information input from the user. The display device 910 has a screen such as a liquid crystal display (LCD) or an organic light emitting diode (OLED) display, and displays an output image of the smartphone 900. The speaker 911 converts the voice signal output from the smartphone 900 into voice.

The radio communication interface 912 supports a cellular communication system such as an LTE or an LTE-advanced and performs radio communication. The radio communication interface 912 may typically include a BB processor 913, an RF circuit 914, and the like. The BB processor 913 may perform, for example, coding/decoding, modulation/demodulation, and multiplexing/demultiplexing, and performs various signal processes for radio communication. On the other hand, the RF circuit 914 may include a mixer, a filter, an amplifier, and the like to transmit and receive radio signals via the antenna 916. The radio communication interface 912 may be a one-chip module in which the BB processor 913 and the RF circuit 914 are integrated. The radio communication interface 912 may include the plurality of BB processors 913 and the plurality of RF circuits 914 as illustrated in FIG. 28. Although FIG. 28 illustrates an example in which the radio communication interface 912 includes the plurality of BB processors 913 and the plurality of RF circuits 914, the radio communication interface 912 may include a single BB processor 913 or a single RF circuit 914.

Further, the radio communication interface 912 may support other types of radio communication systems such as a short-range radio communication system, a near field radio communication system, or a radio local area network (LAN) system in addition to the cellular communication system. In this case, the BB processor 913 and the RF circuit 914 for each radio communication system may be included.

Each of the antenna switches 915 switches the connection destination of the antenna 916 between a plurality of circuits (for example, circuits for different radio communication systems) included in the radio communication interface 912.

Each of the antennas 916 has a single or a plurality of antenna elements (for example, a plurality of antenna elements constituting a MIMO antenna) and is used for transmitting and receiving radio signals by the radio communication interface 912. The smartphone 900 may include a plurality of antennas 916 as illustrated in FIG. 28. Although FIG. 28 illustrates an example in which the smartphone 900 has a plurality of antennas 916, the smartphone 900 may include a single antenna 916.

Further, the smartphone 900 may include the antenna 916 for each radio communication system. In this case, the antenna switch 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to each block of the smartphone 900 illustrated in FIG. 28 via the power supply line partially illustrated by the broken line in the figure. The auxiliary controller 919 operates the minimum necessary functions of the smartphone 900, for example, in the sleep mode.

In the smartphone 900 illustrated in FIG. 28, one or a plurality of components (for example, at least one of the communication control unit 241, the information acquisition unit 243, and the notification unit 247) included in the terminal device 200 described with reference to FIG. 3 may be mounted in the radio communication interface 912. Alternatively, at least some of these components may be mounted in the processor 901 or the auxiliary controller 919. As an example, the smartphone 900 may include a module including part (for example, the BB processor 913) or all of the radio communication interface 912, the processor 901, and/or the auxiliary controller 919, and the one or the plurality of components may be mounted in the module. In this case, the module may store a program for causing the processor to function as the one or the plurality of components (in other words, a program for causing the processor to perform the operation of the one or the plurality of components) to execute the program. As another example, a program for causing the processor to function as the one or the plurality of components may be installed in the smartphone 900, and the radio communication interface 912 (for example, the BB processor 913), the processor 901, and/or the auxiliary controller 919 may execute the program. As described above, the smartphone 900 or the module may be provided as a device including the one or the plurality of components, and a program for causing the processor to function as the one or the plurality of components may be provided. Further, a readable recording medium on which the above program is recorded may be provided.

Further, in the smartphone 900 illustrated in FIG. 28, for example, the radio communication unit 220 described with reference to FIG. 3 may be mounted in the radio communication interface 912 (for example, the RF circuit 914). Further, the antenna unit 210 may be mounted in the antenna 916. Further, the storage unit 230 may be mounted in the memory 902.

### Second Application Example

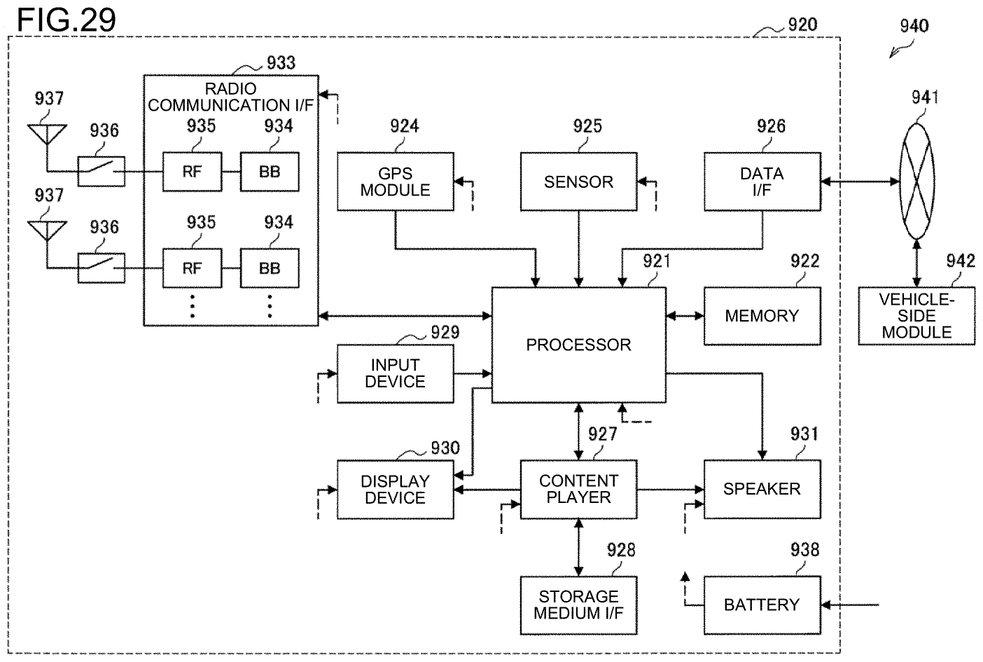

FIG. 29 is a block diagram illustrating an example of a schematic configuration of a car navigation device 920 to which the technique according to the present disclosure can be applied. The car navigation device 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or a plurality of antenna switches 936, one or a plurality of antennas 937, and a battery 938.

The processor 921 may be, for example, a CPU or an SoC, and controls the navigation function and other functions of the car navigation device 920. The memory 922 includes a RAM and a ROM and stores programs executed by the processor 921 and data.

The GPS module 924 uses GPS signals received from GPS satellites to measure the position (for example, latitude, longitude, and altitude) of the car navigation device 920. The sensor 925 may include, for example, a group of sensors such as a gyro sensor, a geomagnetic sensor, and an atmospheric pressure sensor. The data interface 926 is connected to an in-vehicle network 941 via a terminal (not illustrated) to acquire data generated from the vehicle such as vehicle speed data.

The content player 927 plays content stored on a storage medium (for example, a CD or a DVD) inserted into the storage medium interface 928. The input device 929 includes, for example, a touch sensor that detects a touch on the screen of the display device 930, a button, or a switch, and receives an operation or information input from the user. The display device 930 has a screen such as an LCD or an OLED display and displays an image of a navigation function or a content to be played. The speaker 931 outputs a sound of a navigation function or a content to be played.

The radio communication interface 933 supports a cellular communication system such as an LTE or an LTE-advanced and performs radio communication. The radio communication interface 933 may typically include a BB processor 934, an RF circuit 935, and the like. The BB processor 934 may perform, for example, coding/decoding, modulation/demodulation, multiplexing/demultiplexing, and the like, and performs various signal processes for radio communication. On the other hand, the RF circuit 935 may include a mixer, a filter, an amplifier, and the like to transmit and receive radio signals via the antenna 937. The radio communication interface 933 may be a one-chip module in which the BB processor 934 and the RF circuit 935 are integrated. The radio communication interface 933 may include the plurality of BB processors 934 and the plurality of RF circuits 935 as illustrated in FIG. 29. Although FIG. 29 illustrates an example in which the radio communication interface 933 includes the plurality of BB processors 934 and the plurality of RF circuits 935, the radio communication interface 933 includes a single BB processor 934 or a single RF circuit 935.

Further, the radio communication interface 933 may support other types of radio communication systems such as a short-range radio communication system, a near field radio communication system, or a radio LAN system in addition to the cellular communication system. In this case, the BB processor 934 and the RF circuit 935 for each radio communication system may be included.

Each of the antenna switches 936 switches the connection destination of the antenna 937 between a plurality of circuits (for example, circuits for different radio communication systems) included in the radio communication interface 933.

Each of the antennas 937 has a single or a plurality of antenna elements (for example, a plurality of antenna elements constituting a MIMO antenna) and is used for transmitting and receiving radio signals by the radio communication interface 933. The car navigation device 920 may include a plurality of antennas 937 as illustrated in FIG. 29. Although FIG. 29 illustrates an example in which the car navigation device 920 includes a plurality of antennas 937, the car navigation device 920 may include a single antenna 937.

Further, the car navigation device 920 may include the antenna 937 for each radio communication system. In this case, the antenna switch 936 may be omitted from the configuration of the car navigation device 920.

The battery 938 supplies electric power to each block of the car navigation device 920 illustrated in FIG. 29 via the power supply line partially illustrated by a broken line in the figure. In addition, the battery 938 stores electric power supplied from the vehicle.

In the car navigation device 920 illustrated in FIG. 29, one or a plurality of components (for example, at least one of the communication control unit 241, the information acquisition unit 243, and the notification unit 247) included in the terminal device 200 described with reference to FIG. 3 described with reference to FIG. 3 may be mounted in the radio communication interface 933. Alternatively, at least some of these components may be mounted in the processor 921. As an example, the car navigation device 920 includes a module including part (for example, the BB processor 934) or all of the radio communication interface 933 and/or the processor 921, and the one or the plurality of components may be mounted in the module. In this case, the module may store a program for causing the processor to function as the one or the plurality of components (in other words, a program for causing the processor to perform the operation of the one or the plurality of components) to execute the program. As another example, a program for causing the processor to function as the one or the plurality of components may be installed in the car navigation device 920, and the radio communication interface 933 (for example, the BB processor 934) and/or the processor 921 may execute the program. As described above, the car navigation device 920 or the module may be provided as a device including the one or the plurality of components, or a program for causing the processor to function as the one or the plurality of components may be provided. Further, a readable recording medium on which the above program is recorded may be provided.

Further, in the car navigation device 920 illustrated in FIG. 29, for example, the radio communication unit 220 described with reference to FIG. 3 may be mounted in the radio communication interface 933 (for example, the RF circuit 935). Further, the antenna unit 210 may be mounted in the antenna 937. Further, the storage unit 230 may be mounted in the memory 922.

Further, the technique according to the present disclosure may be realized as an in-vehicle system (or vehicle) 940 including one or a plurality of blocks of the car navigation device 920 described above, the in-vehicle network 941, and a vehicle-side module 942. The vehicle-side module 942 generates vehicle data such as a vehicle speed, an engine rotation speed, or failure information, to output the generated data to the in-vehicle network 941.

### 5. SUMMARY

As described above, according to the embodiments of the present disclosure, a new QoS control method is provided in order to realize highly reliable and low-delay QoS-guaranteed communication on the side link.

Although the embodiments of the present disclosure is described mainly for V2X communication, the present disclosure is not limited to such an example, and it goes without saying that it can be applied to use cases other than V2X communication because it is an extension of the side link. For example, the technique illustrated in the embodiments of the present disclosure can be applied to D2D communication, MTC communication, moving cell, relay communication, and the like. The embodiments of the present disclosure may also be applied to multi-carrier communication in which side link communication is performed using a plurality of carriers.

The base station 100 illustrated in FIG. 2 can function as an example of the control device of the present disclosure. Then, in the configuration of the base station 100 illustrated in FIG. 2, the radio communication unit 120 can function as the communication unit of the control device of the present disclosure, and the control unit 150 can function as the control unit of the control device of the present disclosure.

The terminal device 200 illustrated in FIG. 3 can function as an example of the communication device of the present disclosure. Then, in the configuration of the terminal device 200 illustrated in FIG. 3, the radio communication unit 220 can function as the communication unit of the communication device of the present disclosure, and the control unit 240 can function as the control unit of the communication device of the present disclosure. Further, the terminal device 200 may be a device provided in a moving body. The moving body can be a vehicle.

Each step in the process performed by each device of the present specification does not necessarily have to be processed in chronological order in the order described as a sequence diagram or a flowchart. For example, each step in the process executed by each device may be processed in an order different from the order described in the flowchart, or may be processed in parallel.

In addition, it is possible to create a computer program for causing the hardware such as a CPU, a ROM, and a RAM built in each device to exhibit the same functions as the configuration of each device described above. It is also possible to provide a storage medium storing the computer program. Further, it is possible to realize a series of processes by hardware by configuring each functional block illustrated in the functional block diagram with the hardware.

The preferred embodiments of the present disclosure have been described in detail with reference to the accompanying drawings, but the technical scope of the present disclosure is not limited to such examples. It is obvious that those skilled in the art in the technical field of the present disclosure can find various revisions and modifications within the scope of a technical concept described in claims, and it should be understood that these revisions and modifications will also be naturally come under the technical scope of the present disclosure.

Furthermore, the effects described in the present specification are merely illustrative or exemplified effects, and are not limitative. That is, the technique according to the present disclosure can accomplish other effects apparent to those skilled in the art from the description of the present specification, in addition to or instead of the effects described above.

Note that the following configurations also belong to the technical scope of the present disclosure.
(1)

A communication device comprising:

a communication unit that performs radio communication; and

a control unit that performs control so as to switch an HARQ feedback mode in a communication scheme of inter-device communicating with another device through the communication unit between a first mode in which NACK-based feedback is performed and a second mode in which ACK/NACK-based feedback is performed, wherein

the control unit controls switching of an HARQ feedback mode based on information about an identifier of a group including the communication device and information about the number of devices in the group.
(2)

The communication device according to (1), wherein the control unit controls switching of an HARQ feedback mode further based on a priority of a packet communicated through the communication unit.
(3)

The communication device according to (1) or (2), wherein the control unit controls transmission timing of HARQ feedback communicated through the communication unit.
(4)

The communication device according to (3), wherein the control unit performs control with respect to the transmission timing of HARQ feedback communicated through the communication unit to switch between transmission for each packet and transmission for a plurality of packets at once.
(5)

The communication device according to any one of (1) to (4), wherein the control unit further changes a resource used in the inter-device communication based on an identifier of a group including the communication device.
(6)

The communication device according to any one of (1) to (5), wherein the control unit controls switching of an HARQ feedback mode further based on a degree of congestion of a resource used in the inter-device communication.
(7)

The communication device according to (6), wherein the control unit switches an HARQ feedback mode from a second mode to a first mode when the degree of congestion is equal to or higher than a predetermined threshold value.
(8)

The communication device according to any one of (1) to (7), wherein the control unit determines the other device that executes HARQ feedback from a group including the communication device.
(9)

The communication device according to (8), wherein the control unit randomly determines the other device that executes HARQ feedback.
(10)

The communication device according to any one of (1) to (9), wherein the control unit derives a required shortest communication distance based on information about an identifier of a group including the communication device.
(11)

The communication device according to (10), wherein the control unit determines a transmission parameter of the communication unit based on the derived required shortest communication distance.
(12)

The communication device according to any one of (1) to (11), wherein the control unit controls traffic of an application that performs the inter-device communication.
(13)

The communication device according to (12), wherein the control unit controls the traffic based on information about a packet transmitted from the communication unit.
(14)

The communication device according to (12) or (13), wherein the control unit controls the traffic based on information about a communication environment of the communication device.
(15)

The communication device according to (14), wherein information about the communication environment is acquired by the communication device performing sensing.
(16)

The communication device according to (14), wherein information about the communication environment is acquired by a notification from another device.
(17)

The communication device according to any one of (1) to (16), wherein the communication device is a device provided in a moving body.
(18)

The communication device according to (17), wherein the moving body is a vehicle.
(19)

A control device comprising:

a communication unit that performs radio communication with a terminal device; and

a control unit that performs control so as to switch an HARQ feedback mode in a communication scheme in which the terminal device performs inter-device communication with another device between a first mode in which NACK-based feedback is performed and a second mode in which ACK/NACK-based feedback is performed, wherein

the control unit controls switching of an HARQ feedback mode based on information about an identifier of a group including the terminal device and information about the number of devices in the group.
(20)

A communication system comprising at least two communication devices according to any one of (1) to (18).

### REFERENCE SIGNS LIST

1 SYSTEM

100 BASE STATION

200 TERMINAL DEVICE

1. A communication device comprising:
a communication unit that performs radio communication; and
a control unit that performs control so as to switch an HARQ feedback mode in a communication scheme of inter-device communicating with another device through the communication unit between a first mode in which NACK-based feedback is performed and a second mode in which ACK/NACK-based feedback is performed, wherein
the control unit controls switching of an HARQ feedback mode based on information about an identifier of a group including the communication device and information about the number of devices in the group.

2. The communication device according to claim 1, wherein the control unit controls switching of an HARQ feedback mode further based on a priority of a packet communicated through the communication unit.

3. The communication device according to claim 1, wherein the control unit controls transmission timing of HARQ feedback communicated through the communication unit.

4. The communication device according to claim 3, wherein the control unit performs control with respect to the transmission timing of HARQ feedback communicated through the communication unit to switch between transmission for each packet and transmission for a plurality of packets at once.

5. The communication device according to claim 1, wherein the control unit further changes a resource used in the inter-device communication based on an identifier of a group including the communication device.

6. The communication device according to claim 1, wherein the control unit controls switching of an HARQ feedback mode further based on a degree of congestion of a resource used in the inter-device communication.

7. The communication device according to claim 6, wherein the control unit switches an HARQ feedback mode from a second mode to a first mode when the degree of congestion is equal to or higher than a predetermined threshold value.

8. The communication device according to claim 1, wherein the control unit determines the other device that executes HARQ feedback from a group including the communication device.

9. The communication device according to claim 8, wherein the control unit randomly determines the other device that executes HARQ feedback.

10. The communication device according to claim 1, wherein the control unit derives a required shortest communication distance based on information about an identifier of a group including the communication device.

11. The communication device according to claim 10, wherein the control unit determines a transmission parameter of the communication unit based on the derived required shortest communication distance.

12. The communication device according to claim 1, wherein the control unit controls traffic of an application that performs the inter-device communication.

13. The communication device according to claim 12, wherein the control unit controls the traffic based on information about a packet transmitted from the communication unit.

14. The communication device according to claim 12, wherein the control unit controls the traffic based on information about a communication environment of the communication device.

15. The communication device according to claim 14, wherein information about the communication environment is acquired by the communication device performing sensing.

16. The communication device according to claim 14, wherein information about the communication environment is acquired by a notification from another device.

17. The communication device according to claim 1, wherein the communication device is a device provided in a moving body.

18. The communication device according to claim 17, wherein the moving body is a vehicle.

19. A control device comprising:
a communication unit that performs radio communication with a terminal device; and
a control unit that performs control so as to switch an HARQ feedback mode in a communication scheme in which the terminal device performs inter-device communication with another device between a first mode in which NACK-based feedback is performed and a second mode in which ACK/NACK-based feedback is performed, wherein
the control unit controls switching of an HARQ feedback mode based on information about an identifier of a group including the terminal device and information about the number of devices in the group.

20. A communication system comprising at least two communication devices according to claim 1.
